(19) United States
(12) Patent Application Publication
(10) Pub. No.: US 2026/0216629 A1
(43) Pub. Date: Jul. 30, 2026

(54) WATERPROOF MEMBER AND WATERPROOF CASE

(71) Applicant: NITTO DENKO CORPORATION, Osaka (JP)

(72) Inventors: Hajime YAMAMOTO, Osaka (JP); Tamao FUKUSHIMA, Osaka (JP)

(73) Assignee: NITTO DENKO CORPORATION, Osaka (JP)

(21) Appl. No.: 19/137,753

(22) PCT Filed: Dec. 13, 2023
(86) PCT No.: PCT/JP2023/044747

§ 371 Date: Jun. 11, 2025

(30) Foreign Application Priority Data
Dec. 28, 2022 (JP) 2022-211981

(51) Int. Cl. B01D 46/54; A45C 11/00; A45C 13/00; B01D 69/02; B01D 71/24; B01D 71/36; H04R 1/02; H04R 1/08

(52) U.S. Cl. CPC B01D 46/543; A45C 11/002; A45C 13/008; B01D 69/02; B01D 71/24; B01D 71/36; H04R 1/023; H04R 1/086

(57) ABSTRACT

The present invention provides a waterproof member suitable for inhibiting persistence of deformation of a waterproof membrane due to application of water pressure and a waterproof case including the waterproof member. A waterproof member is configured to be disposed to cover an opening of an object having an opening surface having the opening. The waterproof member includes a waterproof membrane having a first principal surface that faces the opening when disposed to cover the opening. The first principal surface of the waterproof membrane has a function of reducing adhesion to a surface facing the principal surface of the waterproof membrane.

### TECHNICAL FIELD

The present invention relates to a waterproof member and a waterproof case including the waterproof member.

### BACKGROUND ART

Many electronic devices including a sound-relating component (acoustic component), which is, for example, a sound emitter, such as a speaker or a buzzer, or a sound receiver, such as a microphone, are carried and used outdoors. Such electronic devices are, for example, wearable devices, such as smartwatches, smartphones, mobile phones, and digital cameras. In recent years, it is required to impart a waterproof function to such electronic devices including an acoustic component while ensuring sound transmission properties. Waterproof smartwatches, waterproof smartphones, etc. are already widespread, and, in order to protect acoustic parts (acoustic components) of such devices, filters (waterproof sound transmission members) having a waterproof sound transmission function are used.

Using a microporous membrane including, for example, polytetrafluoroethylene (hereinafter referred to as “PTFE”) as a waterproof sound transmission member was proposed (refer to Patent Literature 1, for example) before. In addition, a waterproof protective cover member (waterproof member) configured to be disposed over an opening of a tiny product, such as a micro electro mechanical system (MEMS), has been proposed recently (refer to Patent Literature 2, for example).

### CITATION LIST

### Patent Literature

Patent Literature 1: JP 2003-503991 A
Patent Literature 2: JP 2018-501972 A

### SUMMARY OF INVENTION

### Technical Problem

When water pressure is applied to a waterproof member disposed to cover an opening of, for example, a device having an opening surface having the opening, a membrane (waterproof membrane) having a waterproof function warps toward the opening surface and deforms. The present inventors found that sometimes the waterproof membrane does not recover from the deformation and remains deformed even after released from the water pressure. Such persistence of deformation of a waterproof membrane can decrease, for example, the sound transmission properties of a waterproof member.

Therefore, the present invention aims to provide: a waterproof member suitable for inhibiting persistence of deformation of a waterproof membrane due to application of water pressure; and a waterproof case including the waterproof member.

### Solution to Problem

The present invention provides a waterproof member configured to be disposed to cover an opening of an object having an opening surface having the opening, including
a waterproof membrane having a first principal surface that faces the opening when the waterproof member is disposed to cover the opening, wherein
the first principal surface of the waterproof membrane has a function of reducing adhesion to a surface that faces the first principal surface of the waterproof membrane.

In another aspect, the present invention provides a waterproof member configured to be disposed to cover an opening of an object having an opening surface having the opening, including:
a waterproof membrane having a first principal surface that faces the opening when the waterproof member is disposed to cover the opening; and
a supporting layer that is located between the waterproof membrane and the object when the waterproof member is disposed to cover the opening, the supporting layer having a first principal surface facing the first principal surface of the waterproof membrane, wherein
the supporting layer is disposed apart from the waterproof membrane and has air permeability in a thickness direction, and
the first principal surface of the supporting layer has a function of reducing adhesion to the first principal surface of the waterproof membrane.

In still another aspect, the present invention provides a waterproof case including:
a case including a frame having an opening surface having an opening; and
a waterproof member disposed on the frame to cover the opening, the waterproof member including a waterproof membrane having a first principal surface facing the opening, wherein
the opening surface has a function of reducing adhesion to the first principal surface of the waterproof membrane.

### Advantageous Effects of Invention

The present invention can provide a waterproof member suitable for inhibiting persistence of deformation of a waterproof membrane due to application of water pressure, a waterproof case including the waterproof member, and an electronic device including the waterproof member.

### BRIEF DESCRIPTION OF DRAWINGS

FIG. 1A is a cross-sectional view schematically showing an example of a waterproof member according to a first embodiment of the present invention.

FIG. 1B is a perspective view schematically showing the waterproof member of FIG. 1A.

FIG. 2 is a cross-sectional view showing an example of a state where the waterproof member of FIG. 1A is disposed to cover an opening of an object.

FIG. 3 is a schematic cross-sectional view illustrating deformation of a waterproof membrane under application of water pressure to the waterproof member of FIG. 1A.

FIG. 4 is a schematic perspective view illustrating an example of the method for subjecting a first principal surface of the waterproof membrane to an oil-repellent treatment.

FIG. 5A is a cross-sectional view schematically showing another example of the waterproof member according to the first embodiment of the present invention.

FIG. 5B is a perspective view schematically showing the waterproof member of FIG. 5A.

FIG. 6 is a cross-sectional view showing an example of a state where the waterproof member of FIG. 5A is disposed to cover an opening of an object.

FIG. 7A is a schematic cross-sectional view illustrating deformation of the waterproof membrane under application of water pressure to the waterproof member of FIG. 5A.

FIG. 7B is an optical microscope image showing deformation of the waterproof membrane under application of water pressure to the waterproof member of FIG. 5A.

FIG. 8A is a cross-sectional view schematically showing a waterproof member according to a second embodiment of the present invention.

FIG. 8B is a perspective view schematically showing the waterproof member of FIG. 8A.

FIG. 9 is a cross-sectional view showing an example of a state where the waterproof member of FIG. 8A is disposed to cover an opening of an object.

FIG. 10A is a front view schematically showing an example of a waterproof case according to a third embodiment of the present invention.

FIG. 10B is a back view of the waterproof case of FIG. 10A.

FIG. 11A is a cross-sectional view taken along line A-A of FIG. 10A.

FIG. 11B is a cross-sectional view taken along line B-B of FIG. 10A.

FIG. 12A is a top perspective view showing disposition of a waterproof case and an electronic device.

FIG. 12B is a bottom perspective view showing disposition of a waterproof case and an electronic device.

FIG. 13A is a front view schematically showing an example of a waterproof case according to a fourth embodiment of the present invention.

FIG. 13B is a back view of the waterproof case of FIG. 13A.

FIG. 14A is a cross-sectional view taken along line A-A of FIG. 13A.

FIG. 14B is a cross-sectional view taken along line B-B of FIG. 13A.

FIG. 15 is a cross-sectional view showing the configuration of a waterproof body as used in Examples and Comparative Examples.

FIG. 16 is a schematic diagram for illustrating the method for evaluating an insertion loss of a waterproof member.

FIG. 17 shows a change in insertion loss of a waterproof member of Comparative Example 1 before and after a water pressure application test.

### DESCRIPTION OF EMBODIMENTS

A waterproof member according to a first aspect of the present invention is a waterproof member configured to be disposed to cover an opening of an object having an opening surface having the opening, including
a waterproof membrane having a first principal surface that faces the opening when the waterproof member is disposed to cover the opening, wherein
the first principal surface of the waterproof membrane has a function of reducing adhesion to a surface that faces the first principal surface of the waterproof membrane.

According to a second aspect of the present invention, for example, in the waterproof member according to the first aspect, when the waterproof member is disposed to cover the opening, the first principal surface of the waterproof membrane and the opening surface face each other across a space in contact with the first principal surface and the opening surface.

According to a third aspect of the present invention, for example, the waterproof member according to the first aspect further includes a supporting layer disposed apart from the waterproof membrane, the supporting layer having air permeability in a thickness direction, wherein
the supporting layer is located between the waterproof membrane and the object when the waterproof member is disposed to cover the opening.

According to a fourth aspect of the present invention, for example, in the waterproof member according to any one of the first to third aspects, the first principal surface of the waterproof membrane has a surface free energy of 15 mJ/m² or more and 30 mJ/m² or less.

According to a fifth aspect of the present invention, for example, in the waterproof member according to any one of the first to fourth aspects, a water contact angle on the first principal surface of the waterproof membrane is 110° or larger and 120° or smaller.

According to a sixth aspect of the present invention, for example, in the waterproof member according to any one of the first to fifth aspects, a difference between insertion losses measured for sound in a frequency range of 0.1 to 5 kHz before and after a water pressure application test in which a 100 kPa water pressure is applied for 30 minutes to a second principal surface of the waterproof membrane is 1.0 dB or less, the second principal surface being located opposite to the first principal surface of the waterproof membrane.

According to a seventh aspect of the present invention, for example, in the waterproof member according to any one of the first to sixth aspects, the waterproof membrane includes at least one selected from the group consisting of silicone rubber, polyurethane, and polytetrafluoroethylene.

According to an eighth aspect of the present invention, for example, in the waterproof member according to any one of the first to seventh aspects, the first principal surface of the waterproof membrane is subjected to a surface treatment.

According to a ninth aspect of the present invention, for example, in the waterproof member according to any one of the first to eighth aspects, the first principal surface of the waterproof membrane is subjected to an oil-repellent treatment.

According to a tenth aspect of the present invention, for example, in the waterproof member according to any one of the first to ninth aspects, the waterproof membrane includes a colorant.

According to an eleventh aspect of the present invention, for example, the waterproof member according to any one of the first to tenth aspects further includes a pressure-sensitive adhesive layer joined to the first principal surface of the waterproof membrane.

According to a twelfth aspect of the present invention, for example, in the waterproof member according to any one of the third to eleventh aspects,
the supporting layer has a first principal surface that faces the opening when the waterproof member is disposed to cover the opening, and
the waterproof member further includes:
a joining layer joining the first principal surface of the waterproof membrane and a second principal surface of the supporting layer, the second principal surface being located opposite to the first principal surface of the supporting layer; and a pressure-sensitive adhesive layer joined to the first principal surface of the supporting layer.

A waterproof member according to a thirteenth aspect of the present invention is configured to be disposed to cover an opening of an object having an opening surface having the opening, including:
a waterproof membrane having a first principal surface that faces the opening when the waterproof member is disposed to cover the opening; and
a supporting layer that is located between the waterproof membrane and the object when the waterproof member is disposed to cover the opening, the supporting layer having a first principal surface facing the first principal surface of the waterproof membrane, wherein
the supporting layer is disposed apart from the waterproof membrane and has air permeability in a thickness direction, and
the first principal surface of the supporting layer has a function of reducing adhesion to the first principal surface of the waterproof membrane.

According to a fourteenth aspect of the present invention, for example, in the waterproof member according to the thirteenth aspect, the first principal surface of the supporting layer has a surface free energy of 15 mJ/m² or more and 30 mJ/m² or less.

According to a fifteenth aspect of the present invention, for example, in the waterproof member according to the thirteenth or fourteenth aspect, a water contact angle on the first principal surface of the supporting layer is 110° or larger and 120° or smaller.

According to a sixteenth aspect of the present invention, for example, in the waterproof member according to any one of the thirteen to fifteenth aspects, the first principal surface of the supporting layer is subjected to a surface treatment.

According to a seventeenth aspect of the present invention, for example, in the waterproof member according to any one of the thirteenth to sixteenth aspects, the first principal surface of the supporting layer is subjected to an oil-repellent treatment.

A waterproof case according to an eighteenth aspect of the present invention includes:
a case including a frame having an opening surface having an opening; and
a waterproof member disposed on the frame to cover the opening, the waterproof member including a waterproof membrane having a first principal surface facing the opening, wherein
the opening surface has a function of reducing adhesion to the first principal surface of the waterproof membrane.

According to a nineteenth aspect of the present invention, for example, in the waterproof case according to the eighteenth aspect, the first principal surface of the waterproof membrane and the opening surface face each other across a space in contact with the first principal surface and the opening surface.

According to a twentieth aspect of the present invention, for example, in the waterproof case according to the eighteenth or nineteenth aspect, the opening surface has a surface free energy of 15 mJ/m² or more and 30 mJ/m² or less.

According to a twenty-first aspect of the present invention, for example, in the waterproof case according to any one of the eighteenth to twentieth aspects, a water contact angle on the opening surface is 110° or larger and 120° or smaller.

According to a twenty-second aspect of the present invention, for example, in the waterproof case according to any one of the eighteenth to twenty-first aspects, the opening surface is subjected to a surface treatment.

According to a twenty-third aspect of the present invention, for example, in the waterproof case according to any one of the eighteenth to twenty-second aspects, the opening surface is subjected to an oil-repellent treatment.

Hereinafter, embodiments of the present invention will be described with reference to the drawings. The present invention is not limited to the embodiments described below.

### [Waterproof Member]

### First Embodiment

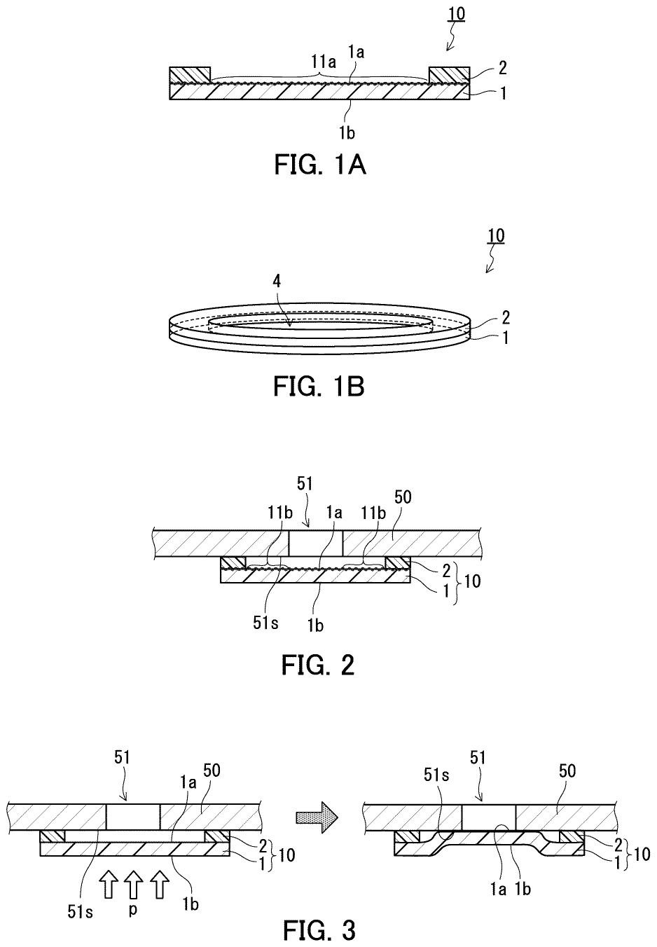

FIGS. 1A and 1B show an example of a waterproof member according to a first embodiment. A waterproof member 10 shown in FIGS. 1A and 1B includes a waterproof membrane 1. FIG. 2 is a cross-sectional view showing an example of a state where the waterproof member 10 is disposed to cover an opening 51 of an object 50. As shown in FIG. 2, when used, the waterproof member 10 is disposed to cover the opening 51 of the object 50 having an opening surface 51s having the opening 51. Herein, the term “opening surface” refers to a surface where an opening is provided, and is a surface having an opening. The same is applicable to the term “sound transmission opening surface”. The object 50 is, for example, an acoustic device or a tiny product, such as a MEMS.

The waterproof membrane 1 is a membrane adapted to permit passage of sound and prevent water ingress. The waterproof membrane 1 has a shape for covering the opening 51. The waterproof membrane 1 has a first principal surface 1a and a second principal surface 1b. When the waterproof membrane 1 is disposed on the object 50, the first principal surface 1a faces the opening 51 and the second principal surface 1b faces the opposite side. Herein, to “face an opening” means to face the opening side. This is not limited to a case where two members face each other, and can also include a case where another member is present between the two members.

As shown in FIG. 2, when the waterproof member 10 is disposed to cover the opening 51, the first principal surface 1a of the waterproof membrane 1 and the opening surface 51s face each other across a space in contact with the first principal surface 1a and the opening surface 51s.

As shown in FIGS. 1A and 1B, the waterproof member 10 includes a pressure-sensitive adhesive layer 2 joined to the first principal surface 1a of the waterproof membrane 1. In the present embodiment, the pressure-sensitive adhesive layer 2 is disposed on a periphery of the first principal surface 1a of the waterproof membrane 1. In FIG. 1B, a reference character 4 indicates a region through which sound passes when the waterproof member 10 is installed on a device, namely, a sound-passing region (sound transmission region).

As shown in FIG. 1A, the first principal surface 1a of the waterproof membrane 1 includes an exposed portion on which the pressure-sensitive adhesive layer 2 is absent. The exposed portion is called an exposed portion 11a. As shown in FIG. 2, when the waterproof member 10 is disposed to cover the opening 51 and viewed in a direction perpendicular to the waterproof membrane 1, the exposed portion 11a of the first principal surface 1a has an overlapping portion 11b overlapping with the opening surface 51s.

The first principal surface 1a of the waterproof membrane 1 has a function of reducing adhesion to a surface that faces the first principal surface 1a of the waterproof membrane 1. As shown in FIG. 2, for the waterproof member 10, the surface that faces the first principal surface 1a of the waterproof membrane 1 is the opening surface 51s. In FIGS. 1A and 2, a portion of the first principal surface 1a is drawn with a wavy line for easy understanding of the invention, the portion having the function of reducing adhesion to the opening surface 51s. In the embodiment shown in FIGS. 1A and 2, the entire first principal surface 1a has the function of reducing adhesion to the opening surface 51s. Note that the entire first principal surface 1a does not need to have the above function. At least the exposed portion 11a of the first principal surface 1a is required to have the above function. That is, for the first principal surface 1a, at least the exposed portion 11a is required to have the above function. The overlapping portion 11b alone may have the above function.

In the waterproof member 10, the first principal surface 1a of the waterproof membrane 1 has a surface free energy E of 15 mJ/m² or more and 30 mJ/m² or less. Note that the entire first principal surface 1a does not need to have the above surface free energy E. At least the exposed portion 11a of the first principal surface 1a is required to have the above surface free energy E. That is, for the first principal surface 1a, at least the exposed portion 11a is required to have a surface free energy E of 15 mJ/m² or more and 30 mJ/m² or less. The overlapping portion 11b alone may have the above surface free energy E.

When water pressure is applied to the waterproof member 10 disposed on the object 50 from the second principal surface 1b side of the waterproof membrane 1, the waterproof membrane 1 warps toward the opening surface 51s and deforms. The present inventors found that sometimes the waterproof membrane 1 does not recover from the deformation and remains deformed even after released from the water pressure. This phenomenon will be described with reference to FIG. 3. FIG. 3 is a schematic cross-sectional view illustrating deformation of the waterproof membrane 1 under application of water pressure p to the waterproof member 10. As shown in FIG. 3, when the water pressure p is applied to the waterproof member 10 from the external side (the second principal surface 1b side) of the object 50, the waterproof membrane 1 is pressed against the opening surface 51s. In the case of a conventional waterproof member, the state where the first principal surface of the waterproof membrane adheres to the opening surface sometimes persists even after the waterproof member is released from the water pressure p. This persistence of deformation of the waterproof membrane can decrease, for example, the sound transmission properties of the waterproof member.

Therefore, the present inventors made intensive studies on methods for inhibiting persistence of deformation of a waterproof membrane due to application of water pressure. That eventually directed the present inventors' attention to the surface free energy between the first principal surface of a waterproof membrane and a surface (for example, an opening surface of an object) that faces the first principal surface.

For the waterproof membrane 1 whose first principal surface 1a has the surface free energy E adjusted in the above range, the degree of adhesion between the first principal surface 1a and the opening surface 51s is suppressed, so that persistence of deformation of the waterproof membrane 1 is inhibited. Specifically, the first principal surface 1a of the waterproof membrane 1 pressed against the opening surface 51s under water pressure on the waterproof member 10 from the second principal surface 1b side easily comes off the opening surface 51s to return to the original shape once released from the water pressure. Hence, the waterproof member 10 of the present embodiment is suitable for inhibiting persistence of deformation of the waterproof membrane 1 due to application of water pressure.

In the waterproof membrane 1, the first principal surface 1a may have a surface free energy of 17 mJ/m² or more. That is, the lower limit of the surface free energy E may be 17 mJ/m². The first principal surface 1a may have a surface free energy of 28 mJ/m² or less. That is, the upper limit of the surface free energy E of the first principal surface 1a may be 28 mJ/m².

### (Method for Calculating Surface Free Energy E)

The surface free energy E of the first principal surface 1a of the waterproof membrane 1 can be calculated by the method described below.

According to Owens-Wendt, surface free energy γ is expressed by the following equation (1).

$$Y = {Y}^{d} + {Y}^{h} \qquad Equation ( 1 )$$

In the equation (1), γ^{d} represents a dispersion energy component, and γ^{h} represents a polar energy component.

On the basis of the equation (1), surface free energy γ_{SV} of a solid is expressed by the following equation (2). Surface free energy γ_{LV} of a liquid is expressed by the following equation (3).

$${Y}_{SV} = {Y}_{SV}^{d} + {Y}_{SV}^{h} \qquad Equation ( 2 )$$

$${Y}_{LV} = {Y}_{LV}^{d} + {Y}_{LV}^{h} \qquad Equation ( 3 )$$

Next, γ_{LV}, γ_{LV}^{d}, and γ_{LV}^{h} are obtained for two liquids L each having known surface free energy γ_{LV} from a literature (R. N. Shimizu, et al., J. Appl. Polym. Sci., 76, 1831-1845 (2000)). In the present embodiment, pure water and diiodomethane are used as the two liquid s L. Table 1 below shows the values of pure water and diiodomethane.

TABLE 1

| | γ_{LV} | γ_{LV}^{d} | γ_{LV}^{h} |
|---|---|---|---|
| Liquid body L | (mN/m) | (mN/m) | (mN/m) |
| Pure water | 72.8 | 22.1 | 50.7 |
| Diiodomethane | 50.8 | 48.5 | 2.3 |

Next, for each of the two liquids L (pure water and diiodomethane), a contact angle θ on a solid is measured using a contact angle measuring device. The contact angle θ can be measured by the same method as the later-described method for measuring a water contact angle θ_{W}.

A linear equation with two unknowns is derived from the Young-Dupre equation below and the values of the two liquids L shown in Table 1 and the measured contact angles θ, the linear equation involving two unknown components (γ_{SV}^{d}, γ_{SV}^{h}) in terms of the surface free energy γ_{SV} of the solid. The surface free energy γ_{SV} of the solid can be determined by solving this equation.

$$\sqrt{{γ}_{SV}^{d} {γ}_{I . V}^{d}} + \sqrt{{γ}_{SV}^{h} {γ}_{LV}^{h}} = \frac{{γ}_{LV} ( 1 + cos θ )}{2}$$

The surface free energy γ_{SV} is calculated for the first principal surface 1a as the solid by the above method. The calculate value is considered the surface free energy E of the first principal surface 1a of the waterproof membrane 1.

The water contact angle θ_{W} on the first principal surface 1a of the waterproof membrane 1 may be 110° or larger and 120° or smaller. The waterproof membrane 1 having the first principal surface 1a on which the water contact angle θ_{W} is in the above range is likely to inhibit persistence of deformation of the waterproof membrane 1. The lower limit of the water contact angle θ_{W} on the first principal surface 1a may be 115°. For the first principal surface 1a, the water contact angle θ_{W} on at least the exposed portion 11a may be 110° or larger and 120° or smaller.

### (Method for Measuring Water Contact Angle θ_{W})

The water contact angle θ_{W} on the first principal surface 1a can be measured according to the sessile drop method in JIS R 3257:1999. Specifically, first, the waterproof membrane 1 is prepared as a sample piece S. In an environment at 25° C., 4 μL of distilled water is dropped to a principal surface of the sample piece S, the principal surface corresponding to the first principal surface 1a. Ten seconds later, a contact angle between the drop of the distilled water and the principal surface is measured using a contact angle measuring device. The measured value is considered the water contact angle θ_{W} on the first principal surface 1a. In the present embodiment, the water contact angle θ_{W} is measured for five sample pieces S, and the average of the measured values is defined as the water contact angle θ_{W} on the first principal surface 1a.

For the waterproof member 10, for example, a difference IL_{D} between insertion losses measured for sound in a frequency range of 0.1 to 5 kHz before and after a water pressure application test in which a 100 kPa water pressure is applied for 30 minutes to the second principal surface 1b is 1.0 dB or less. Saying that the difference IL_{D} between the insertion losses for sound in the frequency range of 0.1 to 5 KHz is 1.0 dB or less means that the difference IL_{D} between the insertion losses does not exceed 1.0 dB in the frequency range of 0.1 to 5 kHz.

### (Method for Measuring Insertion Loss)

The method for measuring the insertion loss of the waterproof membrane 1 for sound in the frequency range of 0.1 to 5 kHz will be described in details in EXAMPLES.

For the waterproof member 10 including the waterproof membrane 1 whose first principal surface 1a has the surface free energy E adjusted in the range of 15 mJ/m² or more and 30 mJ/m² or less, persistence of deformation of the waterproof membrane 1 due to application of water pressure is inhibited, so that the difference IL_{D} between the insertion losses is low. The lower limit of the difference IL_{D} between the insertion losses of the waterproof member 10 is not limited to a particular value. The lower limit of the difference IL_{D} between the insertion losses is, for example, 0 dB.

The thickness of the waterproof membrane 1 is, for example, 10 μm or more and 150 μm or less. Because the thickness of the waterproof membrane 1 is in the above range, the waterproofness and the strength of the waterproof member 10 can be sufficiently ensured. The upper limit of the thickness of the waterproof membrane 1 may be 35 μm, or 30 μm. The lower limit of the thickness of the waterproof membrane 1 may be 10 μm, or 15 μm.

### (Method for Measuring Thickness)

The thickness of the waterproof membrane 1 can be determined by measuring the thickness at any five points on the waterproof membrane 1 and averaging the measured values.

The raw material of the waterproof membrane 1 is not limited to a particular one. The waterproof membrane 1 may include, for example, at least one selected from the group consisting of silicone rubber, polyurethane, and polytetrafluoroethylene. The waterproof membrane 1 may include at least one selected from the group consisting of silicone rubber and polytetrafluoroethylene.

The waterproof membrane 1 may include an elastomer. The waterproof membrane 1 may include the elastomer as its main component. Saying that “the waterproof membrane 1 includes the elastomer as its main component” means that the proportion (mass %) of the elastomer is larger than that of any other component included in the waterproof membrane 1. The same applies to other raw materials of the waterproof membrane 1. The waterproof membrane 1 may consist of the elastomer.

The elastomer included in the waterproof membrane 1 is a rubber-like elastic body. The elastomer is preferably a rubber-like elastic body having rubber hardness. The elastomer may be a thermosetting elastomer or a thermoplastic elastomer. The elastomer is not limited to a particular one. Examples of the elastomer include silicone rubber, urethane rubber, ethylene-propylene-diene rubber (EPDM), acrylic rubber, and natural rubber. One of these or a combination of two or more of these can be used as the elastomer. Among these, silicone rubber or urethane rubber is used desirably. The elastomer may include at least one selected from the group consisting of silicone rubber and urethane rubber.

The elastomer included in the waterproof membrane 1 may be silicone rubber.

The waterproof membrane 1 may include polytetrafluoroethylene. The waterproof membrane 1 may include polytetrafluoroethylene as its main component. The waterproof membrane 1 may consist of polytetrafluoroethylene.

The waterproof membrane 1 may include urethane rubber. The waterproof membrane 1 may include urethane rubber as its main component. The waterproof membrane 1 may consist of urethane rubber.

In the present embodiment, the waterproof membrane 1 is a non-porous membrane. Therefore, the waterproof member 10 is suitable particularly for enhancing waterproofness. In the present embodiment, the term “non-porous” means that a membrane has no or very few pores extending from one principal surface of the membrane to the other principal surface of the membrane. For example, a membrane can be classified as a non-porous membrane when having an air permeability, as expressed by Gurley number, of more than 10,000 seconds/100 mL. The Gurley number is a value obtained by measurement according to JIS P 8117:2009.

In the waterproof member 10, the first principal surface 1a of the waterproof membrane 1 may be subjected to a surface treatment. The first principal surface 1a of the waterproof membrane 1 may have the function of reducing adhesion to the opening surface 51s owing to the surface treatment. Note that the entire first principal surface 1a does not need to be subjected to the surface treatment. At least the exposed portion 11a of the first principal surface 1a is required to be subjected to the surface treatment. The overlapping portion 11b alone may be subjected to the surface treatment. The waterproof membrane 1 may achieve a surface free energy E of 15 mJ/m² or more and 30 mJ/m² or less owing to the surface treatment of the first principal surface 1a.

Examples of the surface treatment include an oil-repellent treatment, a sand blasting treatment, a treatment with sandpaper, a sputter etching treatment, an ion beam treatment, and a laser etching treatment.

In the waterproof member 10, the first principal surface 1a of the waterproof membrane 1 may be subjected to an oil-repellent treatment. Note that the entire first principal surface 1a does not need to be subjected to the oil-repellent treatment. At least the exposed portion 11a of the first principal surface 1a is required to be subjected to the oil-repellent treatment. The overlapping portion 11b alone may be subjected to the oil-repellent treatment. The waterproof membrane 1 may achieve a surface free energy E of 15 mJ/m² or more and 30 mJ/m² or less owing to the oil-repellent treatment of the first principal surface 1a.

It should be noted that the oil-repellent treatment sometimes affects the sound transmission properties (for example, the insertion loss) of the waterproof member 10. Therefore, in the waterproof membrane 1, the second principal surface 1b is preferably not subjected to the oil-repellent treatment.

The oil-repellent treatment can be performed, for example, by applying an oil repellent agent solution to the first principal surface 1a of the waterproof membrane 1 and drying the applied solution. The method for applying the oil repellent agent solution is not limited to a particular one, and, for example, spraying, spin coating, dipping, or roll coating can be employed.

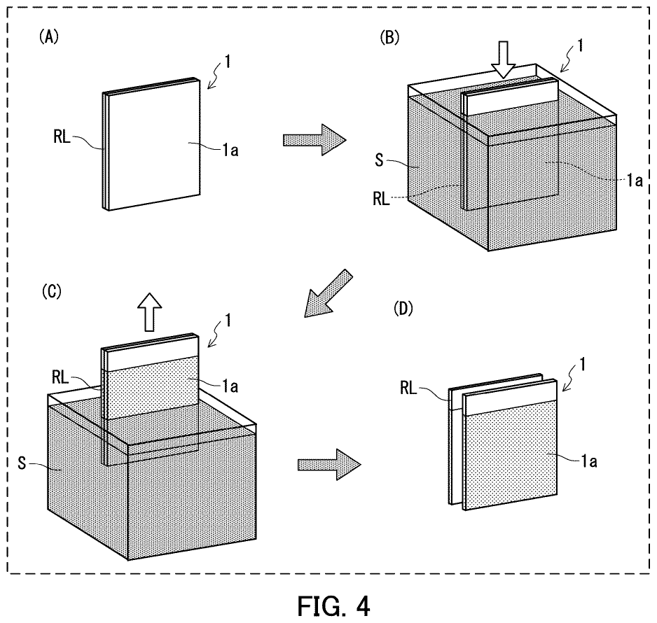

FIG. 4 is a schematic perspective view illustrating an example of the method for subjecting the first principal surface 1a of the waterproof membrane 1 to the oil-repellent treatment. According to the method shown in FIG. 4, first, a release liner RL whose principal surface is as large as the principal surface of the waterproof membrane 1 is adhered to one principal surface (the second principal surface 1b) of the waterproof membrane 1 ((A) of FIG. 4). The release liner RL is not limited to a particular one as long as the release liner RL can prevent an oil repellent agent solution S from having contact with the second principal surface 1b during the oil-repellent treatment. The release liner RL is, for example, a release liner including a fluorosilicone material. Next, the waterproof membrane 1 with the release liner RL is immersed in the oil repellent agent solution S to attach the oil repellent agent solution to the first principal surface 1a ((B) of FIG. 4). The waterproof membrane 1 with the release liner RL is lifted out of the oil repellent agent solution S, followed by drying ((C) of FIG. 4). By peeling the release liner RL off the waterproof membrane 1 after the drying, the waterproof membrane 1 in which only the first principal surface 1a is subjected to the oil-repellent treatment can be obtained ((D) of FIG. 4).

The oil repellent agent concentration in the oil repellent agent solution S is preferably 0.1 to 10 weight %, more preferably 0.5 to 5.0 weight %. The oil repellent agent concentration in the oil repellent agent solution S may be 1.0 weight %.

The oil repellent agent is preferably, but not particularly limited to, a fluorine-based oil-repellent treatment agent. The fluorine-based oil repellent agent is preferably, for example, one or more selected from the group consisting of an acrylic polymer having a fluorine-containing side chain, a urethane polymer having a fluorine-containing side chain, and a silicone polymer having a fluorine-containing side chain.

For example, a mixture of an oil repellent agent a including a polymer including a compound represented by the following chemical formula (a) as a monomer and a solvent can be used as the oil repellent agent.

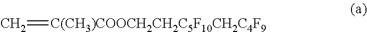

For example, a mixture of an oil repellent agent b including a polymer including a compound represented by the following chemical formula (b) as a monomer and a solvent can be used as the oil repellent agent.

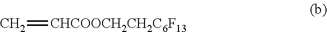

For example, a mixture of an oil repellent agent c including a polymer including a compound represented by the following chemical formula (c) as a monomer and a solvent can be used as the oil repellent agent.

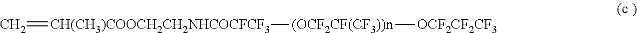

In the chemical formula (c), n is an integer of 1 or greater.

A solution mixture of 1,1,2,2-tetrafluoroethoxy-1-(2,2,2-trifluoro) ethane (hereinafter referred to as HFE-347pc-f) (AE-3000 manufactured by AGC Inc.) and meta-xylene hexafluoride (hereinafter referred to as MX-HF) can be used as the solvent. The mixing ratio of HFE-347pc-f to MX-HF is preferably 3:1 in volume.

A commercially-available product can be used as the above-described fluorine-based oil repellent agent. For example, UNIDYNE (registered trademark) series manufactured by DAIKIN INDUSTRIES, LTD., X-70-029C manufactured by Shin-Etsu Chemical Co., Ltd., and SFCOAT (registered trademark) series (e.g., SIF-200) manufactured by AGC Seimi Chemical Co., Ltd. can be used. Additionally, the fluorine-based oil repellent agent that is the silicone-based polymer is, for example, KP-801M manufactured by Shin-Etsu Chemical Co., Ltd.

The solvent of the oil repellent agent solution S is preferably a fluorine-based solvent having a high affinity for a fluorine-containing side chain. A commercially-available product may be used as the fluorine-based solvent having a high affinity for a fluorine-containing side chain. Examples of the commercially-available product include FS Thinner manufactured by Shin-Etsu Chemical Co., Ltd. and Fluorinert manufactured by Sumitomo 3M Ltd. One of these may be used alone, or a mixture of two or more of these may be used.

The drying after the application of the oil repellent agent solution S is not limited to particular drying, and may be natural drying (air drying) or heat drying. The drying after the application of the oil repellent agent solution S is preferably heat drying at 40° C. to 120° C., more preferably heat drying at 50° C. to 110° C., in terms of high air permeability after attaching the oil.

The raw material of the waterproof membrane 1 may be subjected to a coloring treatment. The waterproof membrane 1 that is transparent or white can be too conspicuous when the waterproof member 10 is disposed to cover an opening of a housing of a device. By coloring the waterproof membrane 1 according to the color of the housing where the waterproof member 10 is to be disposed, the waterproof member 10 that is not too conspicuous when disposed on the housing can be obtained. The waterproof membrane 1 may be colored, for example, black. Moreover, when the design of a housing is given importance, disposing the waterproof member 10 to cover an opening of the housing could damage the design. Therefore, by coloring the waterproof membrane 1 to match the design of the housing, the design can be kept intact.

The waterproof membrane 1 can be colored, for example, by including a colorant in the raw material of the waterproof membrane 1. When attempting to obtain a design-oriented device, the colorant used desirably has a light absorptive capacity, for example, for light in at least part of the wavelength range from 380 nm to 500 nm. In other words, the waterproof membrane 1 is desirably colored black, gray, brown, green, yellow, or pink by this colorant. Examples of the method for coloring the waterproof membrane 1 include: a method in which coloring is performed by mixing a colorant such as a pigment or carbon black with the raw material yet to be formed into a sheet; and a method in which the raw material having been formed into a sheet is colored by a colorant using a dyeing or printing technique. When carbon black is used as the colorant, the strength of the waterproof membrane 1 can be enhanced, and the waterproofness thereof can also be enhanced.

The method for manufacturing the waterproof membrane 1 is not limited to a particular method, and can be selected as appropriate according to the intended use. Either of the following methods, for example, can be adopted: a method in which a raw material solution is extruded into a thin layer form onto a releasable substrate by a discharge means such as a die; and a method in which a raw material solution is cast onto a releasable substrate and is then formed into a thin film by an applicator, a wire bar, or a knife coater. Furthermore, the waterproof membrane 1 may be adjusted to a given thickness by cutting.

In the example shown in FIGS. 1A and 1B, the pressure-sensitive adhesive layer 2 has a ring shape when viewed in a direction perpendicular to the principal surface of the waterproof membrane 1. The shape of the pressure-sensitive adhesive layer 2 is not limited to the shape in the example shown in FIGS. 1A and 1B.

The material of the pressure-sensitive adhesive layer 2 can be selected as appropriate so that the waterproof member 10 can be directly adhered and fixed to an acoustic component to which the waterproof member 10 is to be applied or so that the waterproof member 10 can be adhered and fixed to a housing in which such an acoustic component is to be enclosed. For example, a general-purpose double-faced tape having a substrate, a substrate-less double-faced tape (i.e., a tape consisting of a pressure-sensitive adhesive), or the like can be adopted as appropriate as the pressure-sensitive adhesive layer 2 in view of how firmly the double-faced tape adheres to the waterproof membrane 1 and a housing or a case. In the case where silicone rubber is adopted as the raw material of the waterproof membrane 1, the pressure-sensitive adhesive layer 2 preferably has a surface consisting of a silicone pressure-sensitive adhesive, and the surface consisting of the silicone pressure-sensitive adhesive is preferably a surface in contact with the waterproof membrane 1. This is because silicone pressure-sensitive adhesives have extremely high bonding strength to silicone rubber, compared to other pressure-sensitive adhesives, such as acrylic pressure-sensitive adhesives.

In the example shown in FIGS. 1A and 1B, the waterproof member 10 is circular when viewed in the direction perpendicular to the principal surface of the waterproof membrane 1. The shape of the waterproof member 10 is not limited to the shape in the example shown in FIGS. 1A and 1B. The shape of the waterproof member 10 may be a circle (including a substantially circular shape), an ellipse (including a substantially elliptical shape), or a polygon, such as a rectangular or a square. A corner of the polygon may be rounded.

The thickness of the waterproof member 10 is, for example, 2000 μm or less. The thickness of the waterproof member 10 may be 1000 μm or less, 750 μm or less, 600 μm or less, 500 μm or less, 400 μm or less, or even 300 μm or less. The lower limit of the thickness of the waterproof member 10 is, for example, 50 μm.

### Modification

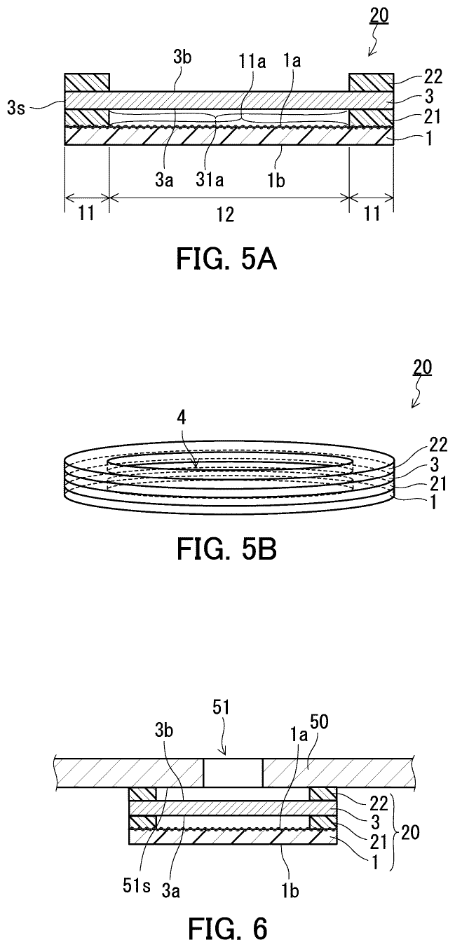

Next, FIGS. 5A and 5B show another example of the waterproof member according to the first embodiment. A waterproof member 20 shown in FIGS. 5A and 5B further includes a supporting layer 3 disposed apart from the waterproof membrane 1, the supporting layer 3 having air permeability in a thickness direction. Hereinafter, the elements of the waterproof member 20 that correspond to those of the waterproof member 10 are denoted by the same reference characters, and detailed descriptions of such components can be omitted.

FIG. 6 is a cross-sectional view showing an example of a state where the waterproof member 20 is disposed to cover the opening 51 of the object 50. As shown in FIG. 6, when the waterproof member 20 is disposed to cover the opening 51, the supporting layer 3 is located between the waterproof membrane 1 and the object 50.

The supporting layer 3 is provided to restrict deformation of the waterproof membrane 1 within a certain range. The supporting layer 3 has a first principal surface 3a and a second principal surface 3b. The first principal surface 3a and the second principal surface 3b face the first principal surface 1a of the waterproof membrane 1 and the opening 51, respectively, when the waterproof member 20 is disposed to cover the opening 51. As shown in FIG. 6, when the waterproof member 20 is disposed to cover the opening 51, the first principal surface 1a of the waterproof membrane 1 and the first principal surface 3a of the supporting layer 3 face each other across a space in contact with the first principal surface 1a and the first principal surface 3a.

The first principal surface 1a of the waterproof membrane 1 has the function of reducing adhesion to a surface facing the first principal surface 1a of the waterproof membrane 1. As shown in FIG. 6, in the waterproof member 20, the surface facing the first principal surface 1a of the waterproof membrane 1 is the first principal surface 3a of the supporting layer 3. In FIG. 5A and FIG. 6, a portion of the first principal surface 1a is drawn with a wavy line for easy understanding of the invention, the portion having the function of reducing adhesion to the first principal surface 3a of the supporting layer 3. In the embodiment of FIG. 5A and FIG. 6, the entire first principal surface 1a has the function of reducing adhesion to the first principal surface 3a of the supporting layer 3. As described for the waterproof member 10, the entire first principal surface 1a does not need to have the above function. That is, for the first principal surface 1a, at least the exposed portion 11a is required to have the above function.

In the waterproof member 20, the first principal surface 1a of the waterproof membrane 1 has a surface free energy E of 15 mJ/m² or more and 30 mJ/m² or less. The entire first principal surface 1a does not need to have the above surface free energy E. At least the exposed portion 11a of the first principal surface 1a is required to have the above surface free energy E. That is, for the first principal surface 1a, at least the exposed portion 11a is required to have a surface free energy E of 15 mJ/m² or more and 30 mJ/m² or less.

As shown in FIGS. 5A and 5B, the waterproof member 20 includes a pressure-sensitive adhesive layer 22 joined to the second principal surface 3b of the supporting layer 3. The pressure-sensitive adhesive layer 22 corresponds to the pressure-sensitive adhesive layer 2 in the waterproof member 10. In the present embodiment, the pressure-sensitive adhesive layer 22 is disposed on a periphery of the second principal surface 3b of the supporting layer 3. In FIG. 5B, the reference character 4 indicates a region through which sound passes when the waterproof member 20 is installed on a device, namely, a sound-passing region (sound transmission region).

As shown in FIGS. 5A and 5B, the waterproof member 20 includes a joining layer 21 joining the first principal surface 1a of the waterproof membrane 1 and the first principal surface 3a of the supporting layer 3. In the present embodiment, the joining layer 21 is disposed on the periphery of the first principal surface 1a of the waterproof membrane 1 and the periphery of the first principal surface 3a of the supporting layer 3.

As shown in FIG. 5A, the first principal surface 1a of the waterproof membrane 1 includes an exposed portion (the exposed portion 11a) on which the joining layer 21 is absent. The first principal surface 3a of the supporting layer 3 includes an exposed portion (an exposed portion 31a) on which the joining layer 21 is absent.

As shown in FIG. 5A, the waterproof member 20 includes a joining region 11 where the waterproof membrane 1 and the supporting layer 3 are joined to each other and a non-joining region 12 surrounded by the joining region 11 when viewed in a direction perpendicular to the principal surface of the waterproof member 20. The joining region 11 includes a region corresponding to the peripheries of the waterproof membrane 1 and the supporting layer 3. The waterproof membrane 1 and the supporting layer 3 are joined by the joining layer 21.

As shown in FIG. 5A, the waterproof membrane 1 and the supporting layer 3 are separated apart from each other in the non-joining region 12. That is, the supporting layer 3 is disposed apart from the waterproof membrane 1 in the non-joining region 12.

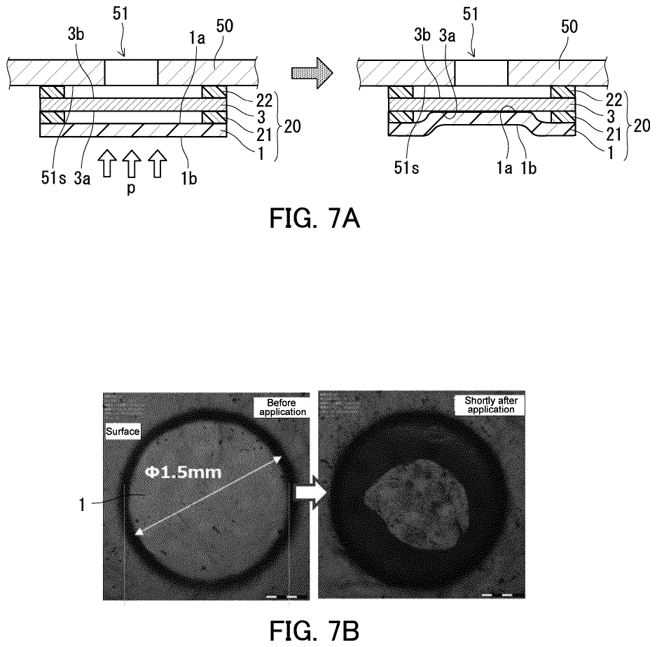

FIG. 7A is a schematic cross-sectional view illustrating deformation of the waterproof membrane 1 under application of the water pressure p to the waterproof member 20. FIG. 7B is an image showing deformation of the waterproof membrane 1 under application of the water pressure p to the waterproof member 20. As shown in FIGS. 7A and 7B, when the water pressure p is applied to the waterproof member 20 from the external side (the second principal surface 1b side) of the object 50, the waterproof membrane 1 is pressed toward the opening surface 51s side, more specifically, against the first principal surface 3a of the supporting layer 3. In the case of a conventional waterproof member, the state where the first principal surface of the waterproof membrane adheres to the first principal surface of the supporting layer sometimes persists even after the waterproof member is released from the water pressure p. Such persistence of deformation of the waterproof membrane can decrease, for example, the sound transmission properties of the waterproof member.

For the waterproof membrane 1 whose first principal surface 1a has the surface free energy E adjusted in the above range, the degree of adhesion between the first principal surface 1a and the first principal surface 3a of the supporting layer 3 is suppressed, so that persistence of deformation of the waterproof membrane 1 is inhibited. Specifically, the first principal surface 1a of the waterproof membrane 1 pressed against the first principal surface 3a of the supporting layer 3 under water pressure on the waterproof member 20 from the second principal surface 1b side easily comes off the first principal surface 3a of the supporting layer 3 to return to the original shape once released from the water pressure. Hence, the waterproof member 20 of Modification is suitable for inhibiting persistence of deformation of the waterproof membrane 1 due to application of water pressure.

For the waterproof member 20, for example, the difference IL_{D} between insertion losses measured for sound in the frequency range of 0.1 to 5 kHz before and after the water pressure application test in which a 100 kPa water pressure is applied for 30 minutes to the second principal surface 1b is 1.0 dB or less. The lower limit of the difference IL_{D} between the insertion losses of the waterproof member 20 is not limited to a particular value. The lower limit of the difference IL_{D} between the insertion losses is, for example, 0 dB.

The thickness of the supporting layer 3 in the non-joining region 12 is, for example, 500 μm or less. In this case, the waterproof member 20 can ensure favorable sound transmission properties even with the supporting layer 3. The thickness of the supporting layer 3 may be 300 μm or less, 250 μm or less, 200 μm or less, 150 μm or less, or even 100 μm or less. The lower limit of the thickness of the supporting layer 3 in the non-joining region 12 is, for example, 30 μm, and may be 50 μm. The supporting layer 3 may have the above thickness not only in the non-joining region 12. The entire supporting layer 3 may have the above thickness.

A separation distance between the waterproof membrane 1 and the supporting layer 3 in the non-joining region 12 is, for example, 150 μm or less. When the separation distance is 150 μm or less, the waterproof member 20 can ensure favorable sound transmission properties even with the supporting layer 3. The separation distance may be 125 μm or less, 100 μm or less, 75 μm or less, or even 50 μm or less. The lower limit of the separation distance is, for example, 5 μm, and may be 10 μm, 20 μm, or even 30 μm.

An air permeability resistance in an inplane direction of the supporting layer 3 may be 100,000 seconds/100 mL or more, 150,000 seconds/100 mL or more, 200,000 seconds/100 mL or more, 250,000 seconds/100 mL or more, 300,000 seconds/100 mL or more, or more than 300,000 seconds/100 mL. The upper limit of the air permeability resistance in the inplane direction of the supporting layer 3 is, for example, 1,000,000 seconds/100 mL or less. The air permeability resistance in the inplane direction of the supporting layer 3 can be evaluated as an air permeability resistance between a portion of the principal surface of the supporting layer 3 included in the waterproof member 20 and an outer peripheral side surface 3s of the supporting layer 3, the portion being located in the non-joining region 12. The term “air permeability resistance” herein means the time it takes for 100 mL of air to pass through the member in the inplane direction (thickness direction).

In the example shown in FIGS. 5A and 5B, the waterproof member 20 and the non-joining region 12 are both circular when viewed in the direction perpendicular to the principal surface of the waterproof membrane 1. The shapes of the waterproof member 20 and the non-joining region 12 are not limited to the shapes in the example shown in FIGS. 5A and 5B. The shapes of the waterproof member 20 and the non-joining region 12 may each independently be a circle (including a substantially circular shape), an ellipse (including a substantially elliptical shape), or a polygon, such as a rectangular or a square. A corner of the polygon may be rounded.

The shape of the joining region 11 is not limited as long as the joining region 11 surrounds the non-joining region 12. The joining region 11 is typically a region including the periphery of the waterproof membrane 1 and/or the periphery of the supporting layer 3. In the example shown in FIGS. 5A and 5B, a region other than the joining region 11 where the waterproof membrane 1 and the supporting layer 3 are joined to each other is the non-joining region 12. In the example shown in FIGS. 5A and 5B, the waterproof membrane 1 is exposed to one surface of the waterproof member 20 (the surface that faces the outside when the waterproof member 20 is disposed on the object 50) in the non-joining region 12. Additionally, the supporting layer 3 is exposed to the other surface of the waterproof member 20 (the surface that faces the opening 51 when the waterproof member 20 is disposed on the object 50) in the non-joining region 12.

The shape of the waterproof membrane 1 and the shape of the supporting layer 3 may be the same or different when viewed in the direction perpendicular to the principal surface of the waterproof membrane 1. In the example shown in FIGS. 5A and 5B, the shape of the waterproof membrane 1 and the shape of the supporting layer 3 are the same, and are also the same as the shape of the waterproof member 20.

The thickness of the waterproof member 20 is, for example, 2000 μm or less. The thickness of the waterproof member 20 may be 1000 μm or less, 750 μm or less, 600 μm or less, 500 μm or less, 400 μm or less, or even 300 μm or less. The lower limit of the thickness of the waterproof member 20 is, for example, 50 μm.

Examples of the material of the supporting layer 3 include a metal, a resin, and a composite material thereof. The material of the supporting layer 3 is preferably a metal for excellent strength as the supporting layer 3. Examples of the metal include aluminum and stainless steel. Examples of the resin include various resins, such as polyolefins (polyethylene, polypropylene, etc.), polyesters (polyethylene terephthalate (PET), etc.), polyamides (various aliphatic polyamides, such as nylon, various aromatic polyamides, etc.), polycarbonates, and polyimides.

A specific example of the supporting layer 3 is a metal plate having one through hole or two or more through holes connecting the first principal surface 3a and the second principal surface 3b. The supporting layer 3 that is the metal plate is excellent particularly in strength. Moreover, when the supporting layer 3 is the metal plate, the rigidity and the handleability as the waterproof member 20 can be enhanced. The through hole extends, for example, in the thickness direction of the supporting layer 3. It is preferable to use the metal plate having two or more through holes because, in that case, the waterproof member 20 having both higher sound transmission properties and higher strength can be obtained. The through hole is required to be in at least the portion located in the non-joining region 12.

When the supporting layer 3 has two or more through holes, the openings of the through holes may be regularly arranged or irregularly positioned on the principal surface when viewed in a direction perpendicular to the principal surface of the metal plate.

The shape of the opening of the through hole is a circle (including a substantially circular shape), an ellipse (including a substantially elliptical shape), or a polygon, such as a square or a rectangular when viewed in the direction perpendicular to the principal surface of the metal plate. A corner of the polygon may be rounded. The shape of the opening of the through hole is not limited to the shape in the above example. In the case where there are two or more through holes, the shapes of the openings of the through holes may be the same or different.

The metal plate having two or more through holes is, for example, a perforated metal. The perforated metal is a metal plate provided with a through hole by punching (press punching).

An opening rate of the supporting layer 3 that is the above metal plate is, for example, 5 to 80%, and may be 15 to 40%, or even 15 to 30%. When the opening rate is in these ranges, the waterproof member 20 having both higher sound transmission properties and higher strength can be obtained. It should be noted that the opening rate of the supporting layer 3 that is the above metal plate is a ratio of the sum of the areas of the openings of all through holes in the principal surface of the supporting layer 3 to the area of the principal surface of the supporting layer 3.

Other examples of the supporting layer 3 include a mesh and a net formed of a metal, a resin, or a composite material thereof.

The air permeability of the supporting layer 3 in the thickness direction is commonly higher than the air permeability of the waterproof membrane 1 in the thickness direction. The air permeability of the supporting layer 3 in the thickness direction is, for example, 10 cm³/(cm²·sec) or more, and may be 100 cm³/(cm²·sec) or more, 300 cm³/(cm² sec) or more, or even more than 500 cm³/(cm²·sec), as expressed in terms of an air permeability (Frazier air permeability) determined according to Method A for air permeability measurement (Frazier method) specified in JIS L 1096:2010. The upper limit of the air permeability of the supporting layer 3 in the thickness direction is, for example, 1000 cm³/(cm² sec) or less in terms of Frazier air permeability.

Even for the supporting layer 3 whose dimensions are smaller than those (about 200 mm×about 200 mm) of a specimen defined in the Frazier method, the Frazier air permeability can be evaluated using a measurement jig for limiting the area of a measurement region. One example of the measurement jig is a resin sheet provided with, at the center thereof, a through hole having a cross-sectional area corresponding to the area of a desirable measurement region. For example, a measurement jig provided with, at the center thereof, a through hole having a circular cross-section and having a diameter equal to or less than 1 mm can be used.

The strength of the supporting layer 3 is commonly higher than that of the waterproof membrane 1.

In the example shown in FIGS. 5A and 5B, the joining layer 21 has a ring shape when viewed in the direction perpendicular to the principal surface of the waterproof membrane 1. The shape of the joining layer 21 is not limited to the shape in the example shown in FIGS. 5A and 5B.

In the example shown in FIGS. 5A and 5B, the pressure-sensitive adhesive layer 22 has a ring shape when viewed in the direction perpendicular to the principal surface of the waterproof membrane 1. The pressure-sensitive adhesive layer 22 is not limited to the shape in the example shown in FIGS. 5A and 5B.

As shown in FIGS. 5A and 5B, the joining layer 21 and the pressure-sensitive adhesive layer 22 may each have a ring shape and may have the same area for joining.

The joining layer 21 is, for example, a pressure-sensitive adhesive layer or an adhesive layer. However, the configuration of the joining layer 21 is not limited as long as the joining region 11 and the non-joining region 22 can be formed. The joining layer 21 that is a pressure-sensitive adhesive layer or an adhesive layer can be formed, for example, by applying a known pressure-sensitive adhesive or adhesive to the periphery of the first principal surface 1a of the waterproof membrane 1. The joining layer 21 may be formed of a double-sided pressure-sensitive adhesive tape. That is, the waterproof membrane 1 and the supporting layer 3 may be joined to each other by a double-sided pressure-sensitive adhesive tape in the joining region 11. When the joining layer 21 is formed of a double-sided pressure-sensitive adhesive tape, the waterproof membrane 1 and the supporting layer 3 are more reliably joined to each other and thus the waterproof member 20 can have further enhanced waterproofness. Moreover, the separation distance between the waterproof membrane 1 and the supporting layer 3 in the non-joining region 12 is more easily controlled.

A known double-sided pressure-sensitive adhesive tape can be used as the double-sided pressure-sensitive adhesive tape forming the joining layer 21. A substrate of the double-sided pressure-sensitive adhesive tape is, for example, a resin film, a non-woven fabric, or a foam. The resin that can be included in the substrate is, for example, but not limited to, a polyester (such as PET), a polyolefin (such as polyethylene), or a polyimide. A variety of pressure-sensitive adhesives, such as acrylic pressure-sensitive adhesives and silicone pressure-sensitive adhesives, can be included in the pressure-sensitive adhesive layer of the double-sided pressure-sensitive adhesive tape. An acrylic pressure-sensitive adhesive is preferably included in the pressure-sensitive adhesive layer because, in that case, a joining force acting between the waterproof membrane 1 and the supporting layer 3 can be enhanced. The double-sided pressure-sensitive adhesive tape may be a thermal adhesive tape.

The thickness of the joining layer 21 is, for example, 150 μm or less. The thickness of the joining layer 21 may be 125 μm or less, 100 μm or less, 75 μm or less, or even 50 μm or less. The lower limit of the thickness of the joining layer 21 is, for example, but not limited to, 5 μm, and may be 10 μm, 20 μm, or even 30 μm.

The materials described for the pressure-sensitive adhesive layer 2 of the waterproof member 10 can be adopted as the material of the pressure-sensitive adhesive layer 22.

The material of the pressure-sensitive adhesive layer 22 may be the same as the material of the joining layer 21. For example, the same double-faced tape may be used as the pressure-sensitive adhesive layer 22 and the joining layer 21.

The method for installing the waterproof members 10 and 20 according to the first embodiment is not limited to a particular one as long as an acoustic component can be protected. For example, the waterproof member 10 or 20 may be directly adhered and fixed by the pressure-sensitive adhesive layer 2 or 22 to an acoustic component to which the waterproof member 10 or 20 is to be applied. Alternatively, the waterproof member 10 or 20 may be adhered and fixed by the pressure-sensitive adhesive layer 2 or 22 to a housing in which such an acoustic component is to be enclosed. In this case, for example, as shown in FIG. 2 and FIG. 6, the waterproof members 10 and 20 are fixed to the object 50 by the pressure-sensitive adhesive layers 2 and 22 such that the waterproof membrane 1 covers the opening 51 provided in the object 50. It should be noted that the opening 51 provided in the object 50 is provided at a position corresponding to the acoustic component so as to allow sound to pass therethrough.

The method for manufacturing the waterproof members 10 and 20 is not limited to a particular method, and a method for manufacturing a conventional waterproof member can be used. For example, the waterproof member 10 can be manufactured by the following method. First, a sheet-shaped raw material for formation of the waterproof membrane 1 and a pressure-sensitive adhesive sheet (for example, a double-faced tape) for formation of the pressure-sensitive adhesive layer 2 are prepared. A hole corresponding to the sound-passing region 4 is formed beforehand in the pressure-sensitive adhesive sheet. This pressure-sensitive adhesive sheet and the sheet-shaped raw material are adhered together, and the resulting product is formed into a given shape by punching. The waterproof member 10 can be obtained in this manner. For example, the waterproof member 20 can be manufactured by the following method.

First, a sheet-shaped raw material for formation of the waterproof membrane 1, a plate-shaped raw material for formation of the supporting layer 3, a first pressure-sensitive adhesive sheet (e.g., double-faced tape) for formation of the joining layer 21, and a second pressure-sensitive adhesive sheet (e.g., double-faced tape) for formation of the pressure-sensitive adhesive layer 22 are prepared. A hole corresponding to the sound-passing region 4 is formed beforehand in the first pressure-sensitive adhesive sheet and the second pressure-sensitive adhesive sheet. The sheet-shaped raw material, the first pressure-sensitive adhesive sheet, the plate-shaped raw material, and the second pressure-sensitive adhesive sheet are adhered together in this order, and the resulting product is formed into a given shape by punching. The waterproof member 20 can be obtained in this manner.

The present embodiment describes the waterproof member 10 in which the waterproof membrane 1 includes the pressure-sensitive adhesive layer 2; however, the waterproof member 10 does not necessarily include the pressure-sensitive adhesive layer 2. In the absence of the pressure-sensitive adhesive layer 2, the waterproof member 10 can be installed at a given position by holding and fixing the waterproof membrane 1 with an O-ring or the like or by fixing the waterproof membrane 1 by resin sealing.

Additionally, although the present embodiment describes the waterproof member 20 in which the supporting layer 3 has the pressure-sensitive adhesive layer 22 thereon, the waterproof member 20 does not necessarily include the pressure-sensitive adhesive layer 22. In such a case, the waterproof member 20 can be installed at a given position by holding and fixing a laminate composed of the waterproof membrane 1, the joining layer 21, and the supporting layer 3 with an O-ring or the like or by fixing the laminate by resin sealing.

Moreover, although not shown, in the waterproof members 10 and 20, a net, a non-woven fabric, or the like may further be provided on the second principal surface 1b side of the waterproof membrane 1 for dust-proofing.

### Second Embodiment

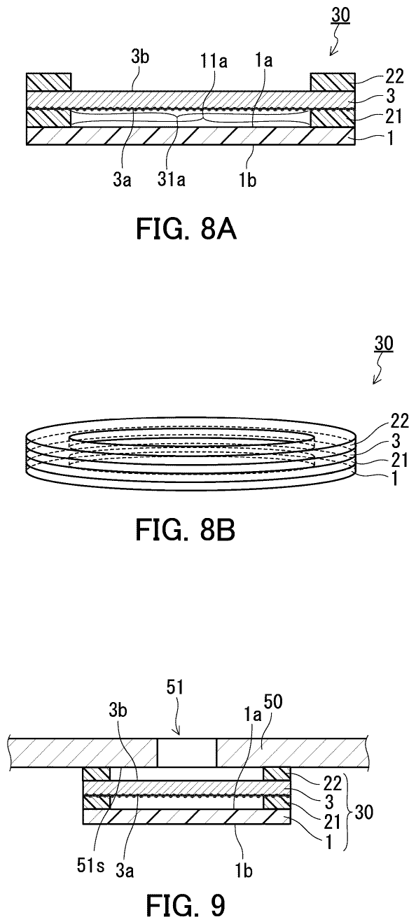

FIGS. 8A and 8B show one example of a waterproof member according to a second embodiment. A waterproof member 30 shown in FIGS. 8A and 8B has the same configuration as that of the waterproof member 20 shown in FIGS. 5A and 5B, except that the first principal surface 3a of the supporting layer 3 has the function of reducing adhesion to the first principal surface 1a of the waterproof membrane 1 instead of the first principal surface 1a of the waterproof membrane 1 having the function of reducing adhesion to a surface facing the first principal surface 1a of the waterproof membrane 1. Hereinafter, the elements of the waterproof member 30 that correspond to those of the waterproof member 20 are denoted by the same reference characters, and detailed descriptions of such components can be omitted.

FIG. 9 is a cross-sectional view showing an example of a state where the waterproof member 30 is disposed to cover the opening 51 of the object 50. In FIG. 8A and FIG. 9, a portion of the first principal surface 3a is drawn with a wavy line for easy understanding of the invention, the portion having the function of reducing adhesion to the first principal surface 1a of the waterproof membrane 1. In the embodiment of FIG. 8A and FIG. 9, the entire first principal surface 3a of the supporting layer 3 has the function of reducing adhesion to the first principal surface 1a of the waterproof membrane 1. Note that the entire first principal surface 3a does not need to have the above function. At least the exposed portion 31a of the first principal surface 3a is required to have the above function. That is, for the first principal surface 3a, at least the exposed portion 31a is required to have the above function.

In the waterproof member 30, the first principal surface 3a of the supporting layer 3 has a surface free energy E of 15 mJ/m² or more and 30 mJ/m² or less. The entire first principal surface 3a does not need to have the above surface free energy E. At least the exposed portion 31a of the first principal surface 3a is required to have the above surface free energy E. That is, for the first principal surface 3a, at least the exposed portion 31a is required to have a surface free energy E of 15 mJ/m² or more and 30 mJ/m² or less.

The surface free energy is a measure of the tendency of attachment between a surface of a solid and another solid. Hence, persistence of deformation of the waterproof membrane 1 can be inhibited also by adjusting the surface free energy E of the first principal surface 3a of the supporting layer 3 facing the first principal surface 1a of the waterproof membrane 1 in the above range, as in the waterproof member 30. Specifically, the first principal surface 1a of the waterproof membrane 1 pressed against the first principal surface 3a of the supporting layer 3 under water pressure on the waterproof member 30 from the second principal surface 1b side easily comes off the first principal surface 3a of the supporting layer 3 to return to the original shape once released from the water pressure. Hence, the waterproof member 30 of the present embodiment is suitable for inhibiting persistence of deformation of the waterproof membrane 1 due to application of water pressure.

The first principal surface 3a of the supporting layer 3 may have a surface free energy of 17 mJ/m² or more. That is, the lower limit of the surface free energy E may be 17 mJ/m². The first principal surface 3a may have a surface free energy of 28 mJ/m² or less. That is, the upper limit of the surface free energy E may be 28 mJ/m².

The surface free energy E of the first principal surface 3a of the supporting layer 3 can be calculated by the same method as that for the first principal surface 1a of the waterproof membrane 1.

The water contact angle θ_{W} on the first principal surface 3a of the supporting layer 3 may be 110° or larger and 120° or smaller. The supporting layer 3 having the first principal surface 3a on which the water contact angle θ_{W} is in the above range is likely to inhibit persistence of deformation of the waterproof membrane 1 located opposite thereto. The lower limit of the water contact angle θ_{W} on the first principal surface 3a may be 115°. For the first principal surface 3a, the water contact angle θ_{W} on at least the exposed portion 31a may be 110° or larger and 120° or smaller.

The water contact angle θ_{W} on the first principal surface 3a of the supporting layer 3 can be measured by the same method as that for the first principal surface 1a of the waterproof membrane 1.

For the waterproof member 30, for example, the difference IL_{D} between insertion losses measured for sound in the frequency range of 0.1 to 5 kHz before and after the water pressure application test in which a 100 kPa water pressure is applied for 30 minutes to the second principal surface 1b is 1.0 dB or less.

For the waterproof member 30 including the supporting layer 3 whose second principal surface 3b has the surface free energy E adjusted in the range of 15 mJ/m² or more and 30 mJ/m² or less, persistence of deformation of the waterproof membrane 1 due to application of water pressure is inhibited, so that the difference IL_{D} between the insertion losses is low. The lower limit of the difference IL_{D} between the insertion losses of the waterproof member 30 is not limited to a particular value. The lower limit of the difference IL_{D} between the insertion losses is, for example, 0 dB.

In the waterproof member 30, the first principal surface 3a of the supporting layer 3 may be subjected to a surface treatment. The first principal surface 3a of the supporting layer 3 may have the function of reducing adhesion to the first principal surface 1a of the waterproof membrane 1 owing to the surface treatment. Note that the entire first principal surface 3a does not need to be subjected to the surface treatment. At least the exposed portion 31a of the first principal surface 3a is required to be subjected to the surface treatment. The waterproof membrane 1 may achieve a surface free energy E of 15 mJ/m² or more and 30 mJ/m² or less owing to the surface treatment of the first principal surface 3a.

Examples of the surface treatment include an oil-repellent treatment, a sand blasting treatment, a treatment with sandpaper, a sputter etching treatment, an ion beam treatment, and a laser etching treatment.

In the waterproof member 30, the first principal surface 3a of the supporting layer 3 may be subjected to the oil-repellent treatment. Note that the entire first principal surface 3a does not need to be subjected to the oil-repellent treatment. At least the exposed portion 31a of the second principal surface 3b is required to be subjected to the oil-repellent treatment. The supporting layer 3 may achieve a surface free energy E of 15 mJ/m² or more and 30 mJ/m² or less owing to the oil-repellent treatment of the first principal surface 3a.

For the above reason, the second principal surface 3b of the supporting layer 3 is preferably not subjected to the oil-repellent treatment.

The oil-repellent treatment can be performed by the same method as that for the first principal surface 1a of the waterproof membrane 1. For example, it is possible to subject only the first principal surface 3a of the supporting layer 3 to the oil-repellent treatment by the same method as the above method shown in FIG. 4.

The applications of the above waterproof members 10 and 20 of the first embodiment and the above waterproof member 30 of the second embodiment are not limited. The waterproof members 10, 20, and 30 can be used in applications where both sound transmission and waterproofness are essential: for example, a waterproof sound transmission structure, an article having a waterproof sound transmission structure, and the like. The waterproof members 10, 20, and 30 are typically included in electronic devices having an audio function. The waterproof members 10, 20, and 30 may be included in tiny products, such as micro electro mechanical systems (MEMS). The waterproof members 10, 20, and 30 may be applied to a circuit board where an acoustic MEMS component is mounted.

### [Waterproof Case]

### Third Embodiment

The waterproof members 10, 20, and 30 can also be applied to a waterproof case in which an electronic device including an acoustic component is to be enclosed. Hereinafter, a waterproof case according to a third embodiment of the present invention will be described.

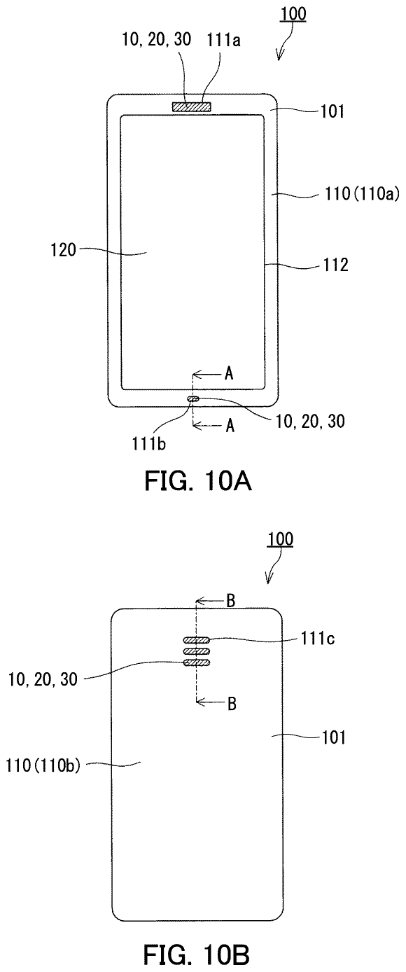

As shown in FIGS. 10A and 10B, a waterproof case 100 according to the third embodiment includes the above waterproof member 10, 20, or 30 and a case 101.

The case 101 includes a frame 110 and a transparent elastic film 120. The frame 110 includes an upper frame 110a and a lower frame 110b. The upper frame 110a has a thin-plate-shaped structure having a rectangular outline and having a rectangular opening arranged at the center. The upper frame 110a has a sound transmission opening surface 111s1 having a sound transmission opening 111a, a sound transmission opening 111b, and an operation opening 112. The lower frame 110b has a shape of a bottomed box having an open top and has a sound transmission opening surface 111s2 having a sound transmission opening 111c in the bottom surface. The transparent elastic film 120 is disposed on and applied to the upper frame 110a to cover the operation opening 112. The transparent elastic film 120 is, for example, a silicone rubber film, a urethane rubber film, or a glass.

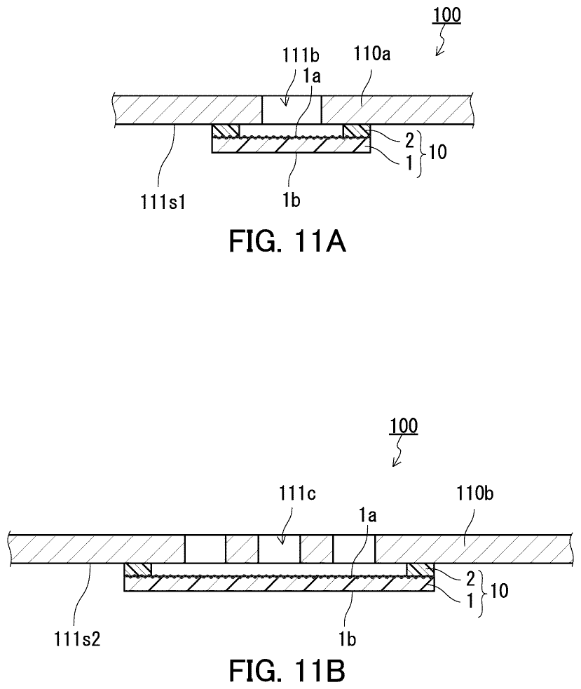

FIG. 11A is a cross-sectional view taken along line A-A of FIG. 10A. FIG. 11B is a cross-sectional view taken along line B-B of FIG. 10A. FIGS. 11A and 11B show a case where the waterproof case 100 includes the waterproof member 10. In FIGS. 11A and 11B, a surface having a surface free energy E of 15 mJ/m² or more and 30 mJ/m² or less is drawn with a wavy line for easy understanding of the invention. As shown in FIG. 11A, the waterproof member 10 is disposed on and joined to the upper frame 110a via the pressure-sensitive adhesive layer 2 to cover the sound transmission opening 111b. Although not shown, the waterproof member 10 is disposed on and joined to the upper frame 110a via the pressure-sensitive adhesive layer 2 to cover the sound transmission opening 111a. As shown in FIG. 11B, the waterproof member 10 is joined to the lower frame 110b via the pressure-sensitive adhesive layer 2 to cover the sound transmission opening 111c.

The waterproof members 10, 11, and 20 are suitable for inhibiting persistence of deformation of the waterproof membrane 1 due to application of water pressure.

Therefore, the waterproof case 100 can achieve excellent waterproofness and excellent sound transmission properties.

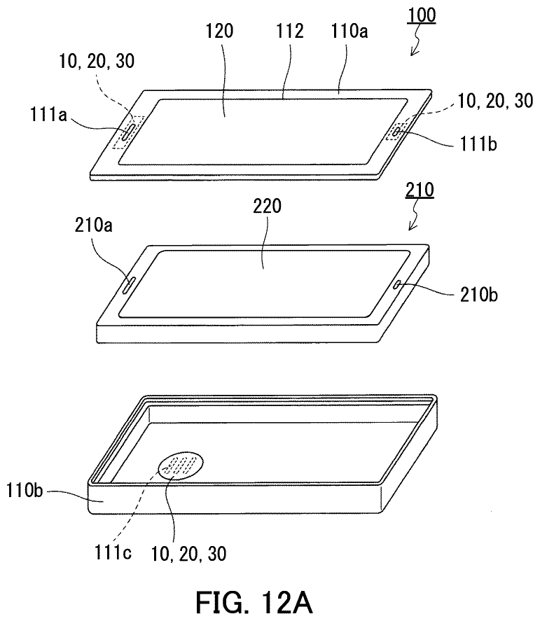

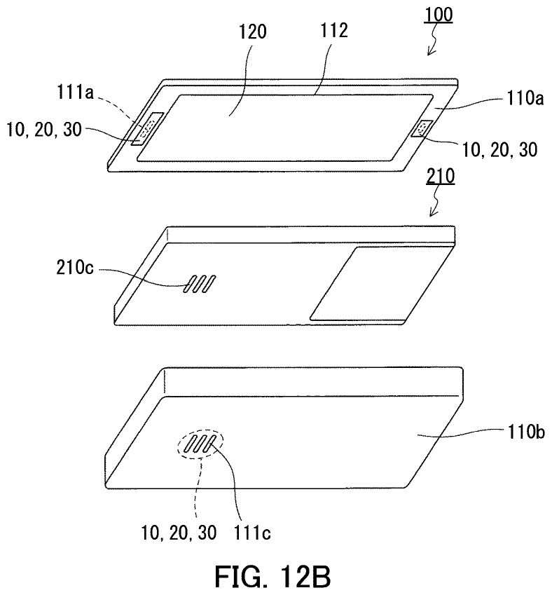

By assembling the upper frame 110a and the lower frame 110b such that the upper frame 110a covers the opening of the lower frame 110b, the inside of the case 101 is made waterproof. Therefore, as shown in FIGS. 12A and 12B, an electronic device 210, such as a smartphone, is disposed between the upper frame 110a and the lower frame 110b to enclose the electronic device 210 inside the case 101, so that the electronic device 210 can be used in an environment where waterproofness is required.

In a state where the electronic device 210 is enclosed inside the case 101, the sound transmission opening 111a is located in a region corresponding to a speaker sound transmission port 210a of the electronic device 210. In a state where the electronic device 210 is enclosed inside the case 101, the sound transmission opening 111b is located in a region corresponding to a microphone sound transmission port 210b of the electronic device 210. In a state where the electronic device 210 is enclosed inside the case 101, the sound transmission opening 111c is located in a region corresponding to a speaker sound transmission port 210c of the electronic device 210. Therefore, in a state where the electronic device 210 is enclosed inside the case 101, sound transmits between a speaker or microphone of the electronic device 210 and the outside of the case 101. Therefore, a user can use the speaker or microphone of the electronic device 210 in a state where the electronic device 210 is enclosed inside the case 101.

In a state where the electronic device 210 is enclosed inside the case 101, the transparent elastic film 120 is in contact with the electronic device 210 to cover a touch panel display 220 of the electronic device 210. A user can operate the display 220 through the transparent elastic film 120 and can view the display 220 through the elastic film 120. As described above, a user can operate the electronic device 210 in a state where the electronic device 210 is enclosed inside the case 101.

### Fourth Embodiment

Next, a waterproof case according to a fourth embodiment of the present invention will be described.

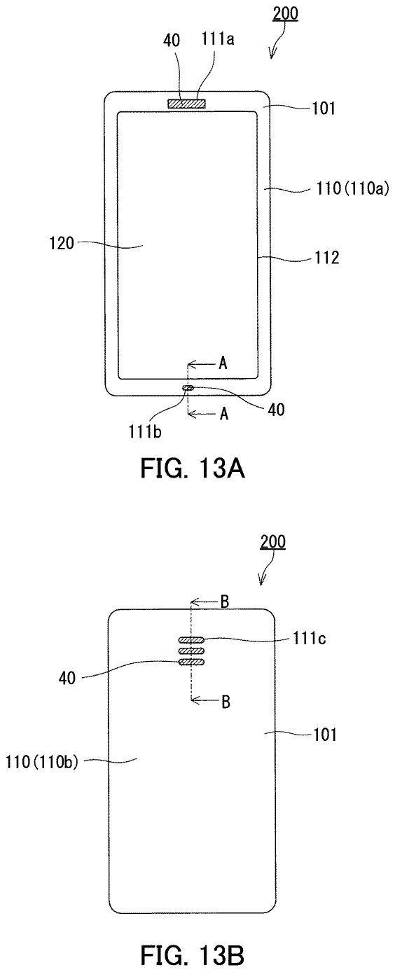

FIGS. 13A and 13B show an example of the waterproof case according to the fourth embodiment. A waterproof case 200 according to the fourth embodiment has the same configuration as that of the waterproof case 100 shown in FIGS. 10A and 10B, except that the sound transmission opening surface 111s (111s1, 111s2) has the function of reducing adhesion to the first principal surface 1a of the waterproof membrane 1 instead of the first principal surface 1a of the waterproof membrane 1 having the function of reducing adhesion to the sound transmission opening surface 111s (111s1, 111s2). Hereinafter, the elements of the waterproof case 200 that correspond to those of the waterproof case 100 are denoted by the same reference characters, and detailed descriptions of such elements can be omitted.

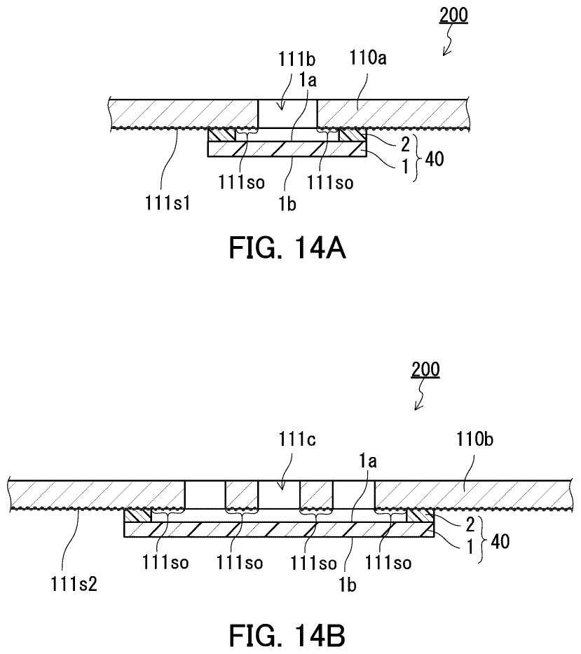

FIG. 14A is a cross-sectional view taken along line A-A of FIG. 13A. FIG. 14B is a cross-sectional view taken along line B-B of FIG. 13A.

As shown in FIGS. 14A and 14B, in the waterproof case 200, the first principal surface 1a of the waterproof membrane 1 and the sound transmission opening surface 111s face each other across a space in contact with the first principal surface 1a and the sound transmission opening surface 111s.

As shown in FIGS. 14A and 14B, a portion of the sound transmission opening surface 111s is called an exposed portion 111so, the portion facing the exposed portion 11a (not shown) of the first principal surface 1a.

In FIGS. 14A and 14B, a portion of the sound transmission opening surface 111s is drawn with a wavy line for easy understanding of the invention, the portion having the function of reducing adhesion to the first principal surface 1a of the waterproof membrane 1. In the embodiment of FIGS. 14A and 14B, the entire sound transmission opening surface 111s has the function of reducing adhesion to the first principal surface 1a of the waterproof membrane 1. Note that the entire sound transmission opening surface 111s does not need to have the above function. At least the exposed portion 111so of the sound transmission opening surface 111s is required to have the above function. That is, for the sound transmission opening surface 111s, at least the exposed portion 111so is required to have the above function.

In the waterproof case 200, the sound transmission opening surface 111s has a surface free energy E of 15 mJ/m² or more and 30 mJ/m² or less. Note that the entire sound transmission opening surface 111s does not need to have the above surface free energy E. At least the exposed portion 111so of the sound transmission opening surface 111s is required to have the above surface free energy E. That is, for the sound transmission opening surface 111s, at least the exposed portion 111so is required to have a surface free energy E of 15 mJ/m² or more and 30 mJ/m² or less.

As shown in FIG. 14A, a waterproof member 40 is disposed on and joined to the upper frame 110a via the pressure-sensitive adhesive layer 2 to cover the sound transmission opening 111b. Although not shown, the waterproof member 40 is disposed on and joined to the upper frame 110a via the pressure-sensitive adhesive layer 2 to cover the sound transmission opening 111a. As shown in FIG. 14B, the waterproof member 40 is joined to the lower frame 110b via the pressure-sensitive adhesive layer 2 to cover the sound transmission opening 111c.

For the above-described reason, persistence of deformation of the waterproof membrane 1 can be inhibited also by adjusting the surface free energy E of the sound transmission opening surface 111s in the above range. Specifically, the first principal surface 1a of the waterproof membrane 1 pressed against the sound transmission opening surface 111s under water pressure on the waterproof member 40 from the second principal surface 2b side easily comes off the sound transmission opening surface 111s to return to the original shape once released from the water pressure. Hence, the waterproof case 200 of the present embodiment is suitable for inhibiting persistence of deformation of the waterproof membrane 1 due to application of water pressure.

The sound transmission opening surface 111s of the frame 110 may have a surface free energy of 17 mJ/m² or more. That is, the lower limit of the surface free energy E may be 17 mJ/m². The sound transmission opening surface 111s may have a surface free energy of 28 mJ/m² or less. That is, the upper limit of the surface free energy E may be 28 mJ/m².

The surface free energy E of the sound transmission opening surface 111s of the frame 110 can be calculated by the same method as that for the first principal surface 1a of the waterproof membrane 1.

The water contact angle θ_{W} on the sound transmission opening surface 111s of the frame 110 may be 110° or larger and 120° or smaller. The frame 110 having the sound transmission opening surface 111s on which the water contact angle θ_{W} is in the above range is likely to inhibit persistence of deformation of the waterproof membrane 1 located opposite thereto. The lower limit of the water contact angle θ_{W} on the sound transmission opening surface 111s may be 115°. For the sound transmission opening surface 111s, the water contact angle θ_{W} on at least the exposed portion 111so may be 110° or larger and 120° or smaller.

The water contact angle θ_{W} on the sound transmission opening surface 111s of the frame 110 can be measured by the same method as that for the first principal surface 1a of the waterproof membrane 1.

For the waterproof member 40 of the waterproof case 200, for example, the difference IL_{D} between insertion losses measured for sound in the frequency range of 0.1 to 5 kHz before and after the water pressure application test in which a 100 kPa water pressure is applied for 30 minutes to the second principal surface 1b of the waterproof membrane 1 is 1.0 dB or less.

For the waterproof case 200 including the frame 110 whose sound transmission opening surface 111s has the surface free energy E adjusted in the range of 15 mJ/m² or more and 30 mJ/m² or less, persistence of deformation of the waterproof membrane 1 due to application of water pressure is inhibited, so that the insertion loss difference IL_{D} of the waterproof member 40 is low. The lower limit of the difference IL_{D} between the insertion losses of the waterproof member 40 is not limited to a particular value. The lower limit of the difference IL_{D} between the insertion losses is, for example, 0 dB.

In the waterproof case 200, the sound transmission opening surface 111s may be subjected to a surface treatment. The sound transmission opening surface 111s of the frame 110 may have the function of reducing adhesion to the first principal surface 1a of the waterproof membrane 1 owing to the surface treatment. Note that the entire sound transmission opening surface 111s does not need to be subjected to the surface treatment. At least the exposed portion 111so of the sound transmission opening surface 111s is required to be subjected to the surface treatment. The frame 110 may achieve a surface free energy E of 15 mJ/m² or more and 30 mJ/m² or less owing to the surface treatment of the surface treatment of the sound transmission opening surface 111s.

Examples of the surface treatment include an oil-repellent treatment, a sand blasting treatment, a treatment with sandpaper, a sputter etching treatment, an ion beam treatment, and a laser etching treatment.

In the waterproof case 200, the sound transmission opening surface 111s of the frame 110 may be subjected to an oil-repellent treatment. Note that the entire sound transmission opening surface 111s does not need to be subjected to the oil-repellent treatment. At least the exposed portion 111so of the sound transmission opening surface 111s is required to be subjected to the oil-repellent treatment. The frame 110 may achieve a surface free energy E of 15 mJ/m² or more and 30 mJ/m² or less owing to the oil-repellent treatment of the sound transmission opening surface 111s.

In the waterproof case 200, a surface of the frame 110 is preferably not subjected to the oil-repellent treatment, the surface being located opposite to the sound transmission opening surface 111s.

The oil-repellent treatment can be performed by the same method as that for the first principal surface 1a of the waterproof membrane 1. For example, it is possible to subject only the sound transmission opening surface 111s of the frame 110 to the oil-repellent treatment by the same method as the above method shown in FIG. 4.

### EXAMPLES

Hereinafter, the present invention will be described more specifically by way of examples. The present invention is not limited to examples shown below.

First, evaluation methods for, for example, waterproof membranes produced in Examples will be described.

The water contact angle θ_{W} and the surface free energy E of the waterproof membranes were evaluated by the methods described above. Contact Angle System OCA 30 manufactured by DataPhysics Instruments GmbH was used as a contact angle measuring device. The measurement of the contact angle was performed in an environment at 25° C.

### [Configuration of Waterproof Member and Object]

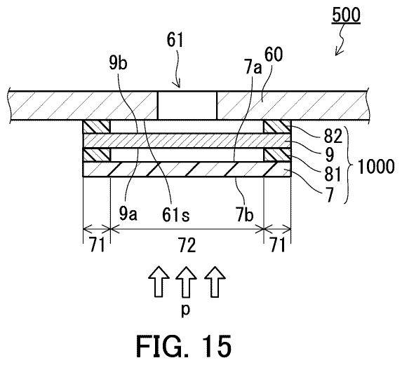

The configuration of a waterproof body 500 as used in Examples and Comparative Examples will be described. As shown in FIG. 15, the waterproof body 500 included a waterproof member 1000 and an object 60. The waterproof member 1000 was disposed to cover an opening 61 of the object 60 having an opening surface 61s having the opening 61. The waterproof member 1000 included a waterproof membrane 7 and a supporting layer 9 disposed apart from the waterproof membrane 7 and having air permeability in a thickness direction. The waterproof membrane 7 had a first principal surface 7a facing the opening 61 and a second principal surface 7b facing the opposite side. The supporting layer 9 had a first principal surface 9a facing the first principal surface 7a of the waterproof membrane 7 and a second principal surface 9b facing the opening 61. The waterproof member 1000 had a joining region 71 where the waterproof membrane 7 and the supporting layer 9 were joined by a joining layer 81 and a non-joining region 72 surrounded by the joining region 71 when viewed in a direction perpendicular to the principal surface of the waterproof member 1000. In the non-joining region 72, the supporting layer 9 was disposed apart from the waterproof membrane 7. The supporting layer 9 was attached to the opening surface 61s via a pressure-sensitive adhesive layer 82. A stainless steel plate was used as the object 60.

### (Method for Measuring Insertion Loss IL and Difference IL_{D} Between Insertion Losses)

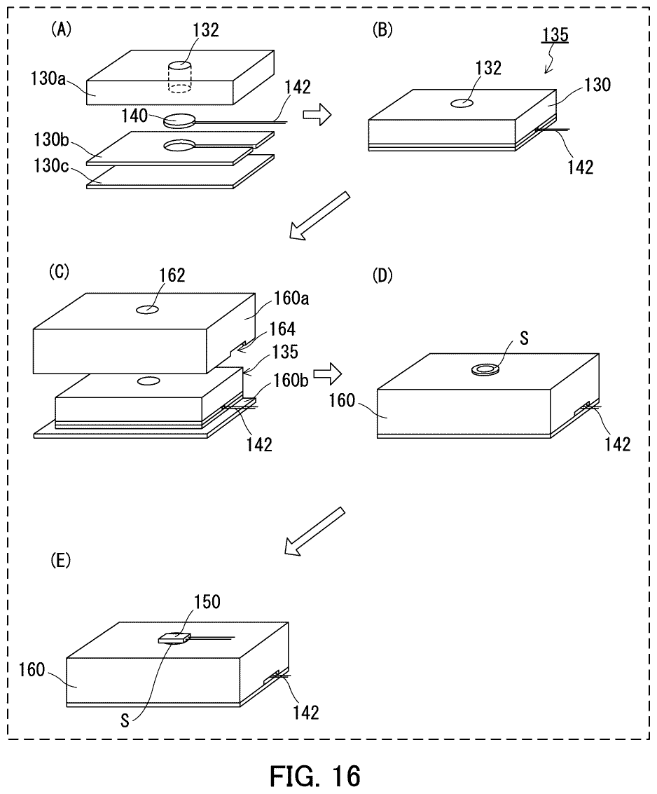

A method for measuring an insertion loss IL of the waterproof member for sound in the frequency range of 0.1 to 5 kHz and the difference IL_{D} between insertion losses will be described using FIG. 16. The insertion loss IL was measured by the following method using a simulated housing shown in FIG. 16 and modeled after a housing of a mobile phone.

As shown in (A) and (B) of FIG. 16, a speaker unit 135 to be enclosed in the simulated housing was produced. The detail is as follows. First, a speaker 140 (SCC-16A manufactured by STAR MICRONICS CO., LTD) as a sound source and fillers 130a, 130b, and 130c for enclosing the speaker 140 and preventing unnecessary diffusion of sound from the speaker (minimizing sound that enters a microphone for evaluation without passing through a waterproof member sample to be evaluated) were prepared, the fillers 130a, 130b, and 130c being formed of urethane sponge. The filler 130a is provided with a sound transmission port 132 having a 5 mm-diameter circular cross-section and extending in a thickness direction of the filler 130a. The filler 130b is provided with a cutout having a shape matching that of the speaker 140 and a cutout in which a speaker cable 142 is to be enclosed and that is for leading the speaker cable 142 to the outside of the speaker unit 135. Next, the fillers 130c and 130b were stacked, and the speaker 140 and the speaker cable 142 were enclosed in the cutouts of the filler 130b. Subsequently, the filler 130a was stacked thereon so that sound would be transmitted from the speaker 140 to the outside of the speaker unit 135 through the sound transmission port 132. The speaker unit 135 was thus obtained ((B) of FIG. 16).

Next, as shown in (C) of FIG. 16, the above speaker unit 135 was enclosed inside a simulated housing 160 (made of polystyrene and having outer dimensions of 60 mm×50 mm×28 mm) modeled after a housing of a mobile phone. The detail is as follows. The simulated housing 160 prepared consists of two portions 160a and 160b, which are able to be fitted to each other. The portion 160a is provided with a sound transmission port 162 (having a 1 mm-diameter circular cross-section) for transmitting sound emitted from the speaker unit 135 enclosed inside to the outside of the simulated housing 160 and a guide hole 164 for leading the speaker cable 142 to the outside of the simulated housing 160. By fitting the portions 160a and 160b together, a space having no openings other than the sound transmission port 162 and the guide hole 164 is created inside the simulated housing 160. The fabricated speaker unit 135 was disposed on the portion 160b, and the portions 160a and 160b were fitted together to enclose the speaker unit 135 inside the simulated housing 160. This was done in such a manner that the sound transmission port 132 of the speaker unit 135 and the sound transmission port 162 of the portion 160a were aligned to transmit sound from the speaker 140 to the outside of the simulated housing 160 through both of the sound transmission holes 132 and 162. The speaker cable 142 was drawn outside the simulated housing 120 through the guide hole 164, and the guide hole 164 was filled with putty.

Next, as shown in (D) of FIG. 16, a sample S (whose non-joining region has an area of 1.8 mm²) of the waterproof member was fixed to the sound transmission port 162 of the simulated housing 160 by a fixing portion (a double-sided pressure-sensitive adhesive tape A) on the waterproof membrane side of the sample. The sample S was fixed such that the entire non-joining region of the sample S was located inside the opening of the sound transmission port 162 when viewed in a direction perpendicular to the principal surface of the waterproof membrane.

Next, as shown in (E) of FIG. 16, a microphone 150 (SPU0410LR5H manufactured by Knowles Acoustics) was fixed on the supporting layer side of the sample S so as to cover the non-joining region of the sample S. The microphone 150 was fixed by a fixing portion (another double-sided pressure-sensitive adhesive tape A) on the supporting layer side of the sample S. A distance between the speaker 140 and the fixed microphone 150 may vary by approximately 2 mm at most depending on the thickness of the waterproof member sample to be evaluated, and was in the range of about 22 mm to about 24 mm. Subsequently, the speaker 140 and the microphone 150 were connected to an acoustic evaluation device (Multi-analyzer System 3560-B-030 manufactured by B&K Sound & Vibration Measurement A/S). A solid state response (SSR) mode (test signal: 20 Hz to 20 kHz; sweep up) was selected as evaluation mode, and an insertion loss of the sample S for sound in the frequency range of 0.1 to 5 kHz was evaluated. The insertion loss was automatically determined on the basis of a test signal input to the speaker 140 from the acoustic evaluation system and a signal received by the microphone 150. The value (blank value) of an insertion loss in the absence of the sample S had been determined in advance of the evaluation of the insertion loss of the sample S. The blank value was-24 dB at a frequency of 1 kHz. The insertion loss of the sample S is a value determined by subtracting the blank value from the value measured by the acoustic evaluation system. A smaller insertion loss indicates better maintenance of the level (volume) of the sound output from the speaker 140.

By the above method, the insertion loss IL of the sample S for sound in the frequency range of 0.1 to 5 kHz was measured before and after a water pressure application test. The difference was considered the difference IL_{D} between the insertion losses of the waterproof member for sound in the frequency range of 0.1 to 5 KHz.

### [Surface Properties of the First Principal Surface of the Waterproof Membrane]

### Comparative Example 1

In the accordance of the above manufacturing method, a shaping process was performed using a silicone rubber to fabricate a membrane having a given thickness. The membrane was a non-porous membrane. The membrane obtained was employed as a waterproof membrane of Comparative Example 1. The first principal surface of the waterproof membrane of Comparative Example 1 was not subjected to an oil-repellent treatment.

The water contact angle θ_{W} and the surface free energy E were evaluated for the first principal surface of the waterproof membrane of Comparative Example 1. Table 2 shows the results.

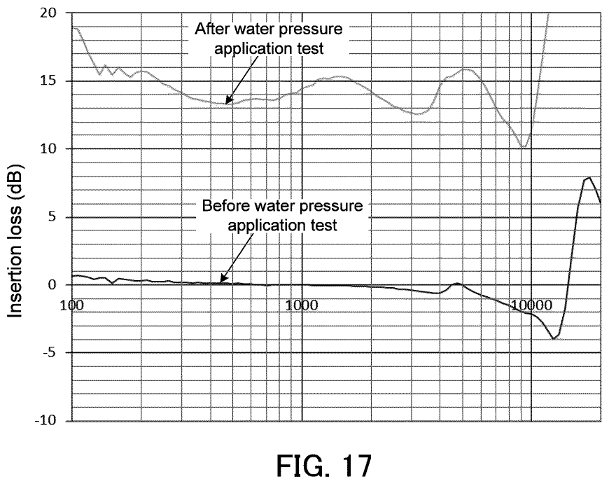

The waterproof membrane of Comparative Example 1 was used as the waterproof membrane 7 of the waterproof member 1000 as shown in FIG. 15. The obtained waterproof member was employed as a waterproof member of Comparative Example 1. The insertion loss (dB) for sound in the frequency range of 0.1 to 20 KHz was measured for the waterproof member of Comparative Example 1. FIG. 17 shows the result.

Next, a 100 kPa water pressure p was applied to the second principal surface 7b of the waterproof membrane 7 of the waterproof member of Comparative Example 1 for 30 minutes in a direction perpendicular to the waterproof membrane 7 (water pressure application test). After the water pressure application test, whether adhesion of the first principal surface 7a of the waterproof membrane 7 to the first principal surface 9a of the supporting layer 9 persisted after the release from the water pressure was visually judged. Table 2 shows the result.

Furthermore, after the water pressure application test, the insertion loss (dB) for sound in the frequency range of 0.1 to 20 KHz was measured for the waterproof member 1000 in which the first principal surface 7a of the waterproof membrane 7 adhered to the first principal surface 9a of the supporting layer 9. FIG. 17 shows the result. As shown in FIG. 17, the insertion loss of the waterproof membrane 7 increased after the water pressure application test.

### Example 1

In the accordance of the above manufacturing method, a shaping process was performed using a silicone rubber to fabricate a membrane having a given thickness. The membrane was a non-porous membrane. One of the principal surfaces of the membrane was subjected to an oil-repellent treatment. A perfluoroalkyl acrylate (1 weight %) represented by the above chemical formula (b) was used as an oil repellent agent. The resulting membrane was employed as a waterproof membrane of Example 1. The principal surface subjected to the oil-repellent treatment was defined as a first principal surface.

The water contact angle θ_{W} and the surface free energy E were evaluated for the first principal surface of the waterproof membrane of Example 1. Table 2 shows the results.

The waterproof membrane of Example 1 was used as the waterproof membrane 7 of the waterproof member 1000 as shown in FIG. 15. The resulting waterproof member was employed as a waterproof member of Example 1. The waterproof member of Example 1 was subjected to the water pressure application test. After the water pressure application test, whether adhesion of the first principal surface of the waterproof membrane 7 to the first principal surface 9a of the supporting layer 9 persisted after the release from the water pressure was visually judged. Table 2 shows the result.

### Example 2

A waterproof membrane and a waterproof member of Example 2 were obtained in the same manner as in Example 1, except that a perfluoroalkyl methacrylate (1 weight %) represented by the above chemical formula (a) was used as the oil repellent agent in the oil-repellent treatment.

The water contact angle θ_{W} and the surface free energy E were evaluated for the first principal surface of the waterproof membrane of Example 2. The waterproof member of Example 2 was subjected to the water pressure application test. After the water pressure application test, whether adhesion of the first principal surface of the waterproof membrane 7 to the first principal surface 9a of the supporting layer 9 persisted after the release from the water pressure was visually judged. Table 2 shows the result.

### Example 3

A waterproof membrane and a waterproof member of Example 3 were obtained in the same manner as in Example 1, except that a perfluoroalkylpolyether (1 weight %) represented by the above chemical formula (c) was used as the oil repellent agent in the oil-repellent treatment.

The water contact angle θ_{W} and the surface free energy E were evaluated for the first principal surface of the waterproof membrane of Example 3. The waterproof member of Example 3 was subjected to the water pressure application test. After the water pressure application test, whether adhesion of the first principal surface of the waterproof membrane 7 to the first principal surface 9a of the supporting layer 9 persisted after the release from the water pressure was visually judged. Table 2 shows the result.

### Example 4

One principal surface of a non-porous PTFE membrane having a given thickness was subjected to an oil-repellent treatment. A perfluoroalkyl acrylate (1 weight %) represented by the above chemical formula (b) was used as an oil repellent agent. The resulting membrane was employed as a waterproof membrane of Example 4. The principal surface subjected to the oil-repellent treatment was defined as a first principal surface.

The water contact angle θ_{W} and the surface free energy E were evaluated for the first principal surface of the waterproof membrane of Example 4. Table 2 shows the results.

The waterproof membrane of Example 4 was used as the waterproof membrane 7 of the waterproof member 1000 as shown in FIG. 15. The resulting waterproof member was employed as a waterproof member of Example 4. The waterproof member of Example 4 was subjected to the water pressure application test. After the water pressure application test, whether adhesion of the first principal surface of the waterproof membrane 7 to the first principal surface 9a of the supporting layer 9 persisted after the release from the water pressure was visually judged. Table 2 shows the result.

TABLE 2

| | | | | Water | Surface free | |
|---|---|---|---|---|---|---|
| | Waterproof | Evaluated | Surface | contact | energy E | Persistence |
| | membrane | surface | treatment | angle θ_{W} (°) | (mJ/m²) | of adhesion |
| Comparative | Silicone | First | Not treated | 105 | 35 | Persist |
| Example 1 | rubber | principal | | | | |
| | | surface of | | | | |
| | | waterproof | | | | |
| | | membrane | | | | |
| Example 1 | Silicone | First | Treated | 119 | 18 | Not persist |
| | rubber | principal | | | | |
| | | surface of | | | | |
| | | waterproof | | | | |
| | | membrane | | | | |
| Example 2 | Silicone | First | Treated | 117 | 24 | Not persist |
| | rubber | principal | | | | |
| | | surface of | | | | |
| | | waterproof | | | | |
| | | membrane | | | | |
| Example 3 | Silicone | First | Treated | 116 | 28 | Not persist |
| | rubber | principal | | | | |
| | | surface of | | | | |
| | | waterproof | | | | |
| | | membrane | | | | |
| Example 4 | Non-porous | First | Treated | 118 | 19 | Not persist |
| | PTFE | principal | | | | |
| | membrane | surface of | | | | |
| | | waterproof | | | | |
| | | membrane | | | | |

### [Surface Properties of Opening Surface]

### Comparative Example 2

A waterproof membrane identical to the one used Comparative Example 1 was used as a waterproof membrane of Comparative Example 2. That is, the first principal surface of the waterproof membrane of Comparative Example 2 was not subjected to an oil-repellent treatment. The waterproof membrane of Comparative Example 2 was used as the waterproof membrane 7 of the waterproof body 500 as shown in FIG. 15. The resulting waterproof body was employed as a waterproof body of Comparative Example 2.

The water contact angle θ_{W} and the surface free energy E were evaluated for the first principal surface 9a of the supporting layer 9 of the waterproof body of Comparative Example 2. Table 3 shows the results.

Next, a 100 kPa water pressure p was applied to the second principal surface 7b of the waterproof membrane 7 of the waterproof body of Comparative Example 2 for 30 minutes in the direction perpendicular to the waterproof membrane 7 (water pressure application test). After the water pressure application test, whether adhesion of the first principal surface of the waterproof membrane 7 to the first principal surface 9a of the supporting layer 9 persisted after the release from the water pressure was visually judged. Table 3 shows the result. [Example 5]

A waterproof membrane identical to the one used Comparative Example 1 was used as a waterproof membrane of Example 5. The first principal surface 9a of the supporting layer 9 of the waterproof body 500 as shown in FIG. 15 was subjected to an oil-repellent treatment. A perfluoroalkyl acrylate (1 weight %) represented by the above chemical formula (b) was used as an oil repellent agent. The resulting waterproof body was employed as a waterproof body of Example 5.

The water contact angle θ_{W} and the surface free energy E were evaluated for the first principal surface 9a of the supporting layer 9 of the waterproof body of Example 5. Table 3 shows the results.

Next, the waterproof body of Example 5 was subjected to the water pressure application test. After the water pressure application test, whether adhesion of the first principal surface of the waterproof membrane 7 to the first principal surface 9a of the supporting layer 9 persisted after the release from the water pressure was visually judged. Table 3 shows the result.

TABLE 3

| | | | | Surface free | |
|---|---|---|---|---|---|
| | Evaluated | Surface | Water contact | energy E | Persistence |
| | surface | treatment | angle θ_{w} (°) | (mJ/m²) | of adhesion |
| Comparative | First principal | Not treated | 71 | 41 | Persist |
| Example 2 | surface of | | | | |
| | supporting | | | | |
| | layer | | | | |
| Example 5 | First principal | Treated | 120 | 17 | Not persist |
| | surface of | | | | |
| | supporting | | | | |
| | layer | | | | |

As shown in Tables 2 and 3, for Examples 1 to 4 where the first principal surface of the waterproof membrane has a surface free energy E of 15 mJ/m² or more and 30 mJ/m² or less and Example 5 where the opening surface of the waterproof body has a surface free energy E of 15 mJ/m² or more and 30 mJ/m² or less, persistence of adhesion between the first principal surface of the waterproof membrane and the second principal surface of the supporting layer was avoided, the second principal surface facing the first principal surface of the waterproof membrane.

### [Sound Transmission Properties of Waterproof Membrane]

### Comparative Example 1

For the waterproof member of Comparative Example 1, the insertion loss IL before the water pressure application test and the difference IL_{D} between the insertion losses before and after the water pressure application test were evaluated. Table 4 shows the results.

### Example 1

For the waterproof member of Example 1, the insertion loss IL before the water pressure application test and the difference IL_{D} between the insertion losses before and after the water pressure application test were evaluated. Table 4 shows the results.

### Example 2

For the waterproof member of Example 2, the insertion loss IL before the water pressure application test and the difference IL_{D} between the insertion losses before and after the water pressure application test were evaluated. Table 4 shows the results.

### Example 3

For the waterproof member of Example 3, the insertion loss IL before the water pressure application test and the difference IL_{D} between the insertion losses before and after the water pressure application test were evaluated. Table 4 shows the results.

### Example 4

For the waterproof member of Example 4, the insertion loss IL before the water pressure application test and the difference IL_{D} between the insertion losses before and after the water pressure application test were evaluated. Table 4 shows the results.

### Example 5

For the waterproof member of Example 5, the insertion loss IL before the water pressure application test and the difference IL_{D} between the insertion losses before and after the water pressure application test were evaluated. Table 4 shows the results.

### Example 6

A waterproof membrane and a waterproof member of Example 6 were obtained in the same manner as in Example 1, except that a perfluoroalkyl acrylate (0.1 weight %) represented by the above chemical formula (b) was used as the oil repellent agent in the oil-repellent treatment. For the waterproof member of Example 6, the insertion loss IL before the water pressure application test and the difference IL_{D} between the insertion losses before and after the water pressure application test were evaluated. Table 4 shows the results.

### Example 7

A waterproof membrane and a waterproof member of Example 7 were obtained in the same manner as in Example 1, except that a perfluoroalkyl acrylate (3 weight %) represented by the above chemical formula (b) was used as the oil repellent agent in the oil-repellent treatment. For the waterproof member of Example 7, the insertion loss IL before the water pressure application test and the difference IL_{D} between the insertion losses before and after the water pressure application test were evaluated. Table 4 shows the results.

### Comparative Example 3

A waterproof membrane and a waterproof member of Comparative Example 3 were obtained in the same manner as in Example 1, except that both principal surfaces of the non-porous membrane were subjected to the oil-repellent treatment. That is, both the first principal surface and the second principal surface of the waterproof membrane of Comparative Example 3 were subjected to the oil-repellent treatment. For the waterproof member of Comparative Example 3, the insertion loss IL before the water pressure application test and the difference IL_{D} between the insertion losses before and after the water pressure application test were evaluated. Table 4 shows the results.

TABLE 4

| | | | | | | Difference |
|---|---|---|---|---|---|---|
| | | | | | | IL_{D} (dB) |
| | | Surface- | | | Insertion | between |
| | Waterproof | treated | Surface | | loss | insertion |
| | membrane | surface | treatment | Oil repellent agent | IL (dB) | losses |
| Comparative | Silicone | — | No | — | 1.2 | 13 |
| Example 1 | rubber | | treated | | | |
| Example 1 | Silicone | First | Treated | Perfluoroalkyl acrylate | 1.6 | 0.3 |
| | rubber | principal | | (1 wt %) | | |
| | | surface of | | | | |
| | | waterproof | | | | |
| | | membrane | | | | |
| Example 2 | Silicone | First | Treated | Perfluoroalkyl | 1.3 | 0.7 |
| | rubber | principal | | methacrylate | | |
| | | surface of | | (1 wt %) | | |
| | | waterproof | | | | |
| | | membrane | | | | |
| Example 3 | Silicone | First | Treated | Perfluoroalkylpolyether | 1.3 | 0.5 |
| | rubber | principal | | (1 wt %) | | |
| | | surface of | | | | |
| | | waterproof | | | | |
| | | membrane | | | | |
| Example 4 | Non- | First | Treated | Perfluoroalkyl acrylate | 2.0 | 0.7 |
| | porous | principal | | (1 wt %) | | |
| | PTFE | surface of | | | | |
| | membrane | waterproof | | | | |
| | | membrane | | | | |
| Example 5 | Silicone | First | Treated | Perfluoroalkyl acrylate | 1.2 | 0.1 |
| | rubber | principal | | (1 wt %) | | |
| | | surface of | | | | |
| | | supporting | | | | |
| | | layer | | | | |
| Example 6 | Silicone | First | Treated | Perfluoroalkyl acrylate | 1.4 | 0.8 |
| | rubber | principal | | (0.1 wt %) | | |
| | | surface of | | | | |
| | | waterproof | | | | |
| | | membrane | | | | |
| Example 7 | Silicone | First | Treated | Perfluoroalkyl acrylate | 1.9 | 0.6 |
| | rubber | principal | | (3 wt %) | | |
| | | surface of | | | | |
| | | waterproof | | | | |
| | | membrane | | | | |
| Comparative | Silicone | First and | Treated | Perfluoroalkyl acrylate | 1.9 | 0.3 |
| Example 3 | rubber | second | | (1 wt %) | | |
| | | principal | | | | |
| | | surfaces of | | | | |
| | | waterproof | | | | |
| | | membrane | | | | |

As shown in Table 4, for Examples 1 to 7, the difference IL_{D} between the insertion losses for sound in the frequency range of 0.1 to 5 kHz before and after the water pressure application test was 1.0 dB or less, which demonstrates excellent sound transmission properties compared to Comparative Example 1.

Additionally, as can be seen by comparing the insertion loss IL of Example 1 before the water pressure application test and the insertion loss IL of Comparative Example 3 before the water pressure application test, the insertion loss increases by subjecting both of the principal surfaces of the waterproof membrane to an oil-repellent treatment. This reveals that the second principal surface of the waterproof membrane is preferably not subjected to an oil-repellent treatment.

### INDUSTRIAL APPLICABILITY

The technique of the present invention can be applied to various electronic devices including: wearable devices such as smart watches; various cameras; communication devices such as mobile phones and smartphones; and sensor devices.

1. A waterproof member configured to be disposed to cover an opening of an object having an opening surface having the opening, comprising
a waterproof membrane having a first principal surface that faces the opening when the waterproof member is disposed to cover the opening, wherein
the first principal surface of the waterproof membrane has a function of reducing adhesion to a surface that faces the first principal surface of the waterproof membrane.

2. The waterproof member according to claim 1, wherein when the waterproof member is disposed to cover the opening, the first principal surface of the waterproof membrane and the opening surface face each other across a space in contact with the first principal surface and the opening surface.

3. The waterproof member according to claim 1, further comprising a supporting layer disposed apart from the waterproof membrane, the supporting layer having air permeability in a thickness direction, wherein
the supporting layer is located between the waterproof membrane and the object when the waterproof member is disposed to cover the opening.

4. The waterproof member according to claim 1, wherein the first principal surface of the waterproof membrane has a surface free energy of 15 mJ/m² or more and 30 mJ/m² or less.

5. The waterproof member according to claim 1, wherein a water contact angle on the first principal surface of the waterproof membrane is 110° or larger and 120° or smaller.

6. The waterproof member according to claim 1, wherein a difference between insertion losses measured for sound in a frequency range of 0.1 to 5 kHz before and after a water pressure application test in which a 100 kPa water pressure is applied for 30 minutes to a second principal surface of the waterproof membrane is 1.0 dB or less, the second principal surface being located opposite to the first principal surface of the waterproof membrane.

7. The waterproof member according to claim 1, wherein the waterproof membrane includes at least one selected from the group consisting of silicone rubber, polyurethane, and polytetrafluoroethylene.

8. The waterproof member according to claim 1, wherein the first principal surface of the waterproof membrane is subjected to a surface treatment.

9. The waterproof member according to claim 1, wherein the first principal surface of the waterproof membrane is subjected to an oil-repellent treatment.

10. The waterproof member according to claim 1, wherein the waterproof membrane includes a colorant.

11. The waterproof member according to claim 2, further comprising a pressure-sensitive adhesive layer joined to the first principal surface of the waterproof membrane.

12. The waterproof member according to claim 3, wherein
the supporting layer has a first principal surface that faces the opening when the waterproof member is disposed to cover the opening, and
the waterproof member further comprises:
a joining layer joining the first principal surface of the waterproof membrane and a second principal surface of the supporting layer, the second principal surface being located opposite to the first principal surface of the supporting layer; and
a pressure-sensitive adhesive layer joined to the first principal surface of the supporting layer.

13. A waterproof member configured to be disposed to cover an opening of an object having an opening surface having the opening, comprising:
a waterproof membrane having a first principal surface that faces the opening when the waterproof member is disposed to cover the opening; and
a supporting layer that is located between the waterproof membrane and the object when the waterproof member is disposed to cover the opening, the supporting layer having a first principal surface facing the first principal surface of the waterproof membrane, wherein
the supporting layer is disposed apart from the waterproof membrane and has air permeability in a thickness direction, and
the first principal surface of the supporting layer has a function of reducing adhesion to the first principal surface of the waterproof membrane.

14. The waterproof member according to claim 13, wherein the first principal surface of the supporting layer has a surface free energy of 15 mJ/m² or more and 30 mJ/m² or less.

15. The waterproof member according to claim 13, wherein a water contact angle on the first principal surface of the supporting layer is 110° or larger and 120° or smaller.

16. The waterproof member according to claim 13, wherein the first principal surface of the supporting layer is subjected to a surface treatment.

17. The waterproof member according to claim 13, wherein the first principal surface of the supporting layer is subjected to an oil-repellent treatment.

18. A waterproof case comprising:
a case including a frame having an opening surface having an opening; and
a waterproof member disposed on the frame to cover the opening, the waterproof member including a waterproof membrane having a first principal surface facing the opening, wherein
the opening surface has a function of reducing adhesion to the first principal surface of the waterproof membrane.

19. The waterproof case according to claim 18, wherein the first principal surface of the waterproof membrane and the opening surface face each other across a space in contact with the first principal surface and the opening surface.

20. The waterproof case according to claim 18, wherein the opening surface has a surface free energy of 15 mJ/m² or more and 30 mJ/m² or less.

21. The waterproof case according to claim 18, wherein a water contact angle on the opening surface is 110° or larger and 120° or smaller.

22. The waterproof case according to claim 18, wherein the opening surface is subjected to a surface treatment.

23. The waterproof case according to claim 18, wherein the opening surface is subjected to an oil-repellent treatment.
